(19) United States
(12) Patent Application Publication
(10) Pub. No.: US 2008/0132239 A1
(43) Pub. Date: Jun. 5, 2008

(54) METHOD AND APPARATUS TO ENABLE HAND-IN FOR FEMTOCELLS

(76) Inventors: Amit Khetawat, San Jose, CA (US); Patrick Tao, San Jose, CA (US); Rajeev Gupta, Sunnyvale, CA (US)

Correspondence Address: Mani Adeli, Esq.;ADELI & TOLLEN LLP, Suite 1360, 1875 Century Park East, Los Angeles, CA, 90067, US

(21) Appl. No.: 11/933,347

(22) Filed: Oct. 31, 2007

Related U.S. Application Data
(60) Provisional application No. 60/863,797, filed on Oct. 31, 2006.
(60) Provisional application No. 60/891,033, filed on Feb. 21, 2007.

(51) Int. Cl. H04Q 7/20

(52) U.S. Cl. 455/438; 455/436

(57) ABSTRACT

Some embodiments provide a method of identifying a list of Femtocell Access Points (FAPs) for a user equipment (UE) communication session in a communication system including a first wireless communication system and a second wireless communication system. The second wireless communication system includes multiple FAPs and a Femtocell gateway (FGW) that communicatively couples the FAPs to the first wireless communication system. The method receives information about a UE that has detected a particular FAP that has an identification attribute. The method uses the UE information to retrieve a set of FAPs designated for the UE where the FAPs in the set of FAPs have the same identification attribute as the particular FAP. The retrieved set of FAPs is from a set of several FAPs that are not designated for the UE but have a same identification attribute as the particular FAP.

### CLAIM OF BENEFIT TO RELATED APPLICATIONS

This application claims the benefit of U.S. Provisional Application 60/863,797, entitled “Method to Enable Seamless Handover as a Component of the Generic Access to the Iu Interface for Femtocell”, filed Oct. 31, 2006; and U.S. Provisional Application 60/891,033, entitled “Method to Enable Hand-in as a Component of the Generic Access to the IU Interface for Femtocells”, filed Feb. 21, 2007. The contents of both of the above mentioned provisional applications are hereby incorporated by reference.

### FIELD OF THE INVENTION

The invention relates to telecommunication. More particularly, this invention relates to a technique for seamlessly integrating voice and data telecommunication services across a licensed wireless system and a short-ranged licensed wireless system.

### BACKGROUND

Cellular telephone systems have existed for decades. The previously existing systems use cellular “towers” (also known as base stations) owned and operated by large cellular telephone companies. These towers provide coverage over large areas. The area of coverage of such a tower is sometimes referred to as a “macrocell”. These towers are positioned to bring the greatest coverage to the greatest number of cellular phone users. However, the coverage of private towers is not uniform. In particular, individual buildings may have weak signals indoors or in radio shadows. For the decades that cellular phones have existed, no one has made and sold a small version of licensed cellular phone towers to individual consumers. The decision to do so has lead to new and previously unknown and unaddressed problems being created.

The fixed, coordinated placement of the towers of the large cellular system, the Universal Terrestrial Radio Access Network (UTRAN), meant that the system could easily identify the location of the tower through which a given piece of user equipment (UE), for example a cellular phone, contacted the network. Thus a tower could “know” which nearby towers were in a position to have a phone call handed off to them. This allowed a handover to be coordinated from the tower a UE was already using, without tying up resources of towers that it might be handed off to until it was actually time to be handed off.

The potential production of millions of individual tiny “towers”, e.g. Femtocell Access Points (FAPs), for the general public creates the new challenge of identifying the physical locations of the FAPs in order for the UTRAN to command a handoff from the UTRAN to the FAPs. Therefore, a new need arises for a good process of handing over calls from cellular towers to FAPs.

### SUMMARY OF THE INVENTION

Some embodiments provide a method of identifying a list of Femtocell Access Points (FAPs) for a user equipment (UE) communication session in a communication system including a first wireless communication system and a second wireless communication system. The second wireless communication system includes multiple FAPs and a Femtocell gateway (FGW) that communicatively couples the FAPs to the first wireless communication system. The method receives information about a UE that has detected a particular FAP that has an identification attribute. The method uses the UE information to retrieve a set of FAPs designated for the UE where the FAPs in the set of FAPs have the same identification attribute as the particular FAP. The retrieved set of FAPs is from a set of several FAPs that are not designated for the UE but have a same identification attribute as the particular FAP.

Some embodiments provide a method of handing over a communication session of a UE in a communication system. The communication system has a first wireless communication system and a second wireless communication system that includes multiple FAPs and an FGW that communicatively couples the FAPs to the first wireless communication system. The method receives a request to hand-in the communication session for a UE to a particular FAP. The request includes an identification of the UE and an identifying parameter of the particular FAP. The method uses the UE identification to identify a set of FAPs that have the same identifying parameter as the particular FAP. The UE is authorized to use the FAPs in the identified set. When the identified set includes at least one FAP, the method sends a handover request to the FAPs in the identified set. The handover request requests that the FAP in the identified list prepare to receive a handover of the communication session from the first wireless communication system to the FAP on the list of authorized FAPs. The handover request is sent without knowing whether the particular FAP is on the identified set of FAPs which the UE is authorized to use.

Some embodiments provide a communication system. The system includes two wireless communication systems. The second wireless communication system includes multiple FAPs, at least one FGW that communicatively couples the FAPs to the first wireless communication system, and a database. The database includes a first set of identifying parameters by which the FAPs are identified to the first communication system. Multiple FAPs share a same set of identifying parameters and cannot be uniquely identified by the first communication system. The database also includes information for uniquely identifying a set of FAPs that a user equipment is authorized to use.

### BRIEF DESCRIPTION OF THE DRAWINGS

FIG. 1 illustrates an overview of a Femtocell based communication system of some embodiments

FIG. 2 illustrates a process for handover of some embodiments.

FIG. 3a illustrates an overview of an integrated communication system (ICS) architecture of some embodiments.

FIG. 3b illustrates part of the system of some embodiments that connects user equipment (UE) to a CN.

FIG. 4a illustrates an embodiment in which a UE can use a single closed Femtocell access point (FAP)

FIG. 4b illustrates a list of allowed FAPs of some embodiments.

FIG. 5 illustrates an embodiment in which a UE can use two closed FAPs.

FIG. 6 illustrates an embodiment in which multiple UEs can all connect to any open FAPs.

FIG. 7a illustrates the geographical scope of single closed FAPs of some embodiments.

FIG. 7b illustrates the geographical scope of multiple closed FAPs of some embodiments.

FIG. 7c illustrates the geographical scope of open FAPs of some embodiments.

FIG. 8 illustrates an embodiment in which FAPs within different macrocells are serviced by the same Femtocell gateway (FGW).

FIG. 9 illustrates an embodiment in which FAPs within different macrocells are serviced by different FGWs.

FIG. 10 illustrates messaging for a successful hand-in of some embodiments.

FIGS. 11-12 illustrate the messaging for failed hand-ins of some embodiments.

FIG. 13 illustrates a process that shows the branching points of messages of FIGS. 10-12.

FIG. 14 illustrates messaging for a successful hand-in of some embodiments.

FIG. 15 illustrates the messaging for a failed hand-in of some embodiments.

FIG. 16 illustrates messaging for a successful hand-in of some embodiments.

FIG. 17 conceptually illustrates a computer system with which some embodiments of the invention are implemented.

### DETAILED DESCRIPTION OF THE INVENTION

The following description, for purposes of explanation, uses specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the provided teachings. The embodiments were chosen and described in order to best explain the principles of the invention and its practical applications, they thereby enable others skilled in the art to best utilize the invention and various embodiments with various modifications as are suited to the particular use contemplated. Moreover, while the invention is described with reference to numerous specific details, one of ordinary skill in the art will recognize that the invention can be embodied in other specific forms without departing from the spirit of the invention.

Some embodiments provide a method of identifying a list of Femtocell Access Points (FAPs) for a user equipment (UE) communication session in a communication system including a first wireless communication system and a second wireless communication system. The second wireless communication system includes multiple FAPs and a Femtocell gateway (FGW) that communicatively couples the FAPs to the first wireless communication system. The method receives information about a UE that has detected a particular FAP that has an identification attribute. The method uses the UE information to retrieve a set of FAPs designated for the UE where the FAPs in the set of FAPs have the same identification attribute as the particular FAP. The retrieved set of FAPs is from a set of several FAPs that are not designated for the UE but have a same identification attribute as the particular FAP.

Some embodiments provide a method of handing over a communication session of a UE in a communication system. The communication system has a first wireless communication system and a second wireless communication system that includes multiple FAPs and an FGW that communicatively couples the FAPs to the first wireless communication system. The method receives a request to hand-in the communication session for a UE to a particular FAP. The request includes an identification of the UE and an identifying parameter of the particular FAP. The method uses the UE identification to identify a set of FAPs that have the same identifying parameter as the particular FAP. The UE is authorized to use the FAPs in the identified set. When the identified set includes at least one FAP, the method sends a handover request to the FAPs in the identified set. The handover request requests that the FAP in the identified list prepare to receive a handover of the communication session from the first wireless communication system to the FAP on the list of authorized FAPs. The handover request is sent without knowing whether the particular FAP is on the identified set of FAPs which the UE is authorized to use.

Some embodiments provide a communication system. The system includes two wireless communication systems. The second wireless communication system includes multiple FAPs, at least one FGW that communicatively couples the FAPs to the first wireless communication system, and a database. The database includes a first set of identifying parameters by which the FAPs are identified to the first communication system. Multiple FAPs share a same set of identifying parameters and cannot be uniquely identified by the first communication system. The database also includes information for uniquely identifying a set of FAPs that a user equipment is authorized to use.

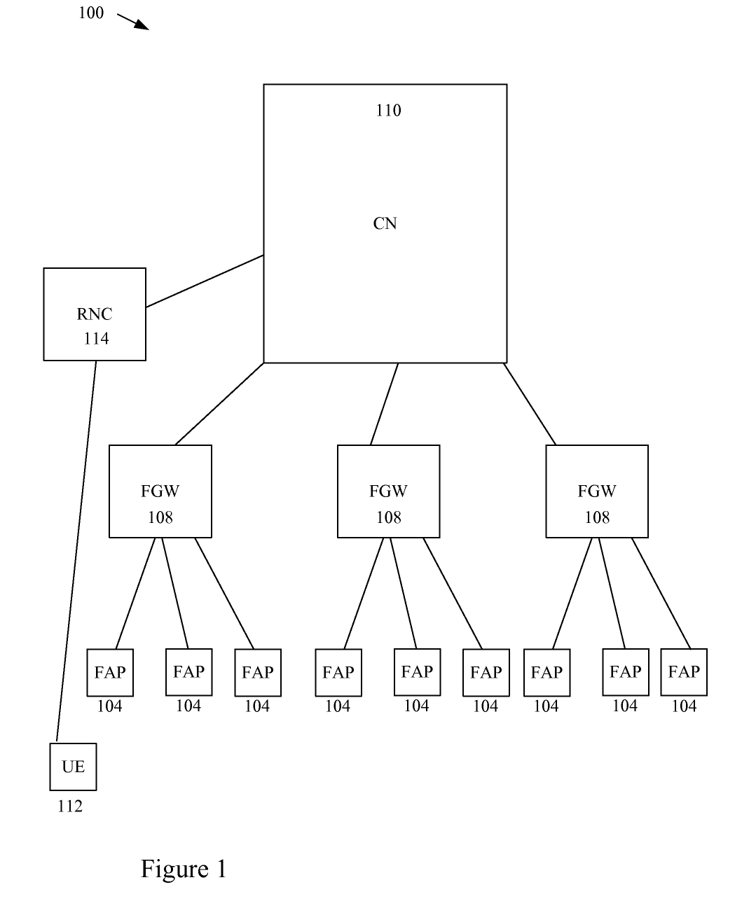

Some embodiments of the invention provide a Femtocell based communication system. One such system 100 is illustrated in FIG. 1. As shown in FIG. 1 multiple Femtocell access points (FAPs) 104 are communicatively connected to Femtocell gateways (FGWs) 108. The FGWs 108 are communicatively connected to a core network (CN) 110 of a licensed wireless system (e.g. a licensed cellular phone system). Each Femtocell access point provides service in a service region to pieces of user equipment (UEs) 112. In some embodiments, UEs 112 also communicably connect to the CN 110 through a Radio Network Controller (RNC) 114. In some embodiments, a communication session can be handed in from the RNC 114 (or a cellular tower communicatively connected to the RNC) to a FAP 108.

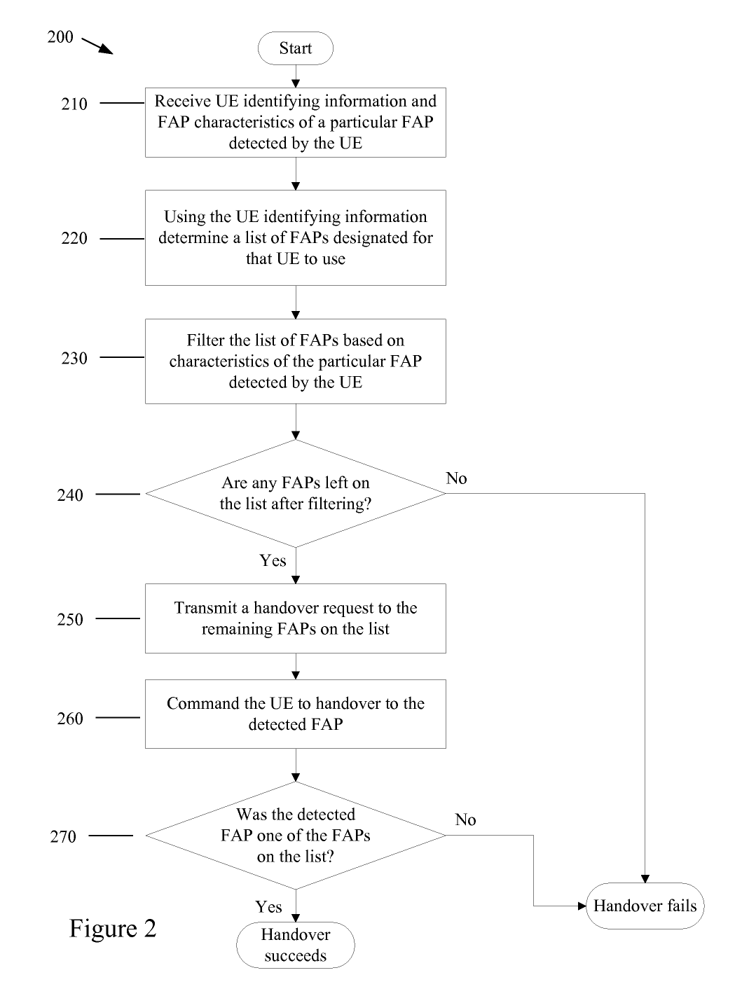

The UE 112 of some embodiments monitors certain frequencies for identification signals from access points including some of FAPs 108. When a strong enough identification signal is detected, a hand-in to the access point generating that identification signal may be attempted. In some embodiments, FAPs 108 are deployed in great numbers. In such embodiments, the number of unique identification signals that a UE 112 is required to be able to detect is smaller than the number of FAPs 108 that are deployed in an area. Because there are not enough unique identification signals, multiple FAPS 108 are assigned the same identification signal. In some embodiments these signals are UMTS Absolute Radio Frequency Channel Numbers (UARFCNs) and scrambling codes (SCs). Therefore, when an identification signal is detected, the identification signal alone is not enough to uniquely identify the particular FAP 108 detected. In some embodiments, when a UE 112 detects a strong enough signal from a FAP 108, the process illustrated in FIG. 2 begins.

FIG. 2 illustrates a process 200 of the hand-in of some embodiments from an RNC to a FAP. If the signal from a detected FAP is strong enough, then the UE sends, to the RNC, a measurement report comprising identifying information for the UE and identification signals of the detected FAP to the CN. The method receives (at 210) this UE identifying information and FAP identification signals of the particular FAP detected by the UE.

Since the CN cannot uniquely identify the detected FAP (because multiple FAPs may be using the same identification signal), the CN commands an FGW that is associated with the RNC to allocate resources for the handover. The command from the CN to the FGW includes identifying information of the UE and the identification signal of the detected FAP.

Using the UE identifying information, the method determines (at 220) a list of FAPs that the identified UE is authorized to use. In some embodiments, this list is stored in an FGW. In some embodiments, the method filters (at 230) that list based on characteristics of the FAP that it detected. The method removes from the list the FAPs that the UE is authorized to use, but which have different identification signals than the detected FAP.

If there are (at 240) no FAPs left on the list then the handover fails. If there are (at 240) any FAPs left on the list, then the method transmits (at 250) a handover request to the FAPs that remain on the list.

The method commands (at 260) that the UE hands over to the detected FAP. The command is given in order to get the UE to hand over to a FAP on the list, however, the UE is in the vicinity of the detected FAP that may or may not be the FAP on the list. Therefore, the UE attempts to hand-in to the detected FAP. If the detected FAP is not (at 270) a FAP on the list, then the handover is rejected by the detected FAP, while the FAP on the list waits for a hand-in attempt that doesn't occur. If the detected FAP is (at 270) a FAP on the list, then the handover succeeds.

In some embodiments the hand-in procedure will work without modification to any part of the UMTS network. In particular, the UE, the RNC, or the CN of some embodiments are standard licensed wireless communications components. In some of such embodiments, the FGW, Femtocell and any other components of the Femtocell system compensate for the limitations of the standard systems.

In some embodiments in which the UMTS network is not modified, at the handover initiation, the SRNC expects the UE to tell it, in a measurement report, a UARFCN, SC for a target cell for handover. The SRNC interprets the UARFCN and SC to mean a single, standard, target cell because a standard system assumes that the target cell is a macrocell.

The SRNC initiates a handover to the target cell which results in a message arriving at the FGW indicating that the target cell for the Relocation Request has the UARFCN and SC that the UE sent to the SRNC in its measurement report. At this point, the FGW does not have enough information to know which FAP the UE has detected because the target cell-id (UARFCN and SC) refers to a set of FAPs and the FGW does not know which FAP the UE has reported to the SRNC.

The FGW then uses the Authorization, Authentication, and Accounting (AAA) Server (or an equivalent function) to generate a FAP list to narrow the candidates FAPs from the total set of FAPs down to a set with only a few FAPs. Since the set is now small enough, the FGW can use the shared handover channel method to complete the handover. If the target cell is an open access point (where the number of candidate FAPs cannot be reduced), the FGW uses the global handover channel to complete the handover.

### I. Overall Architecture of the Integrated Communication System

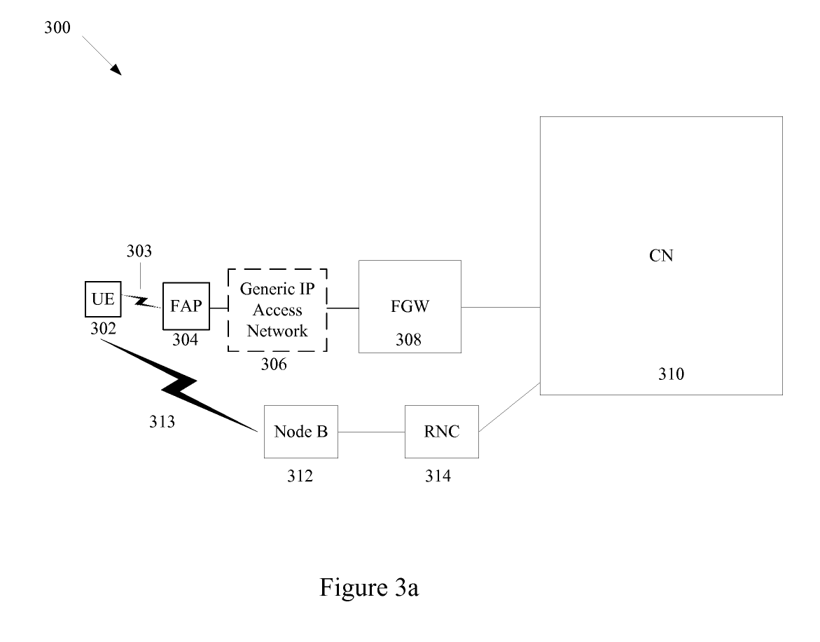

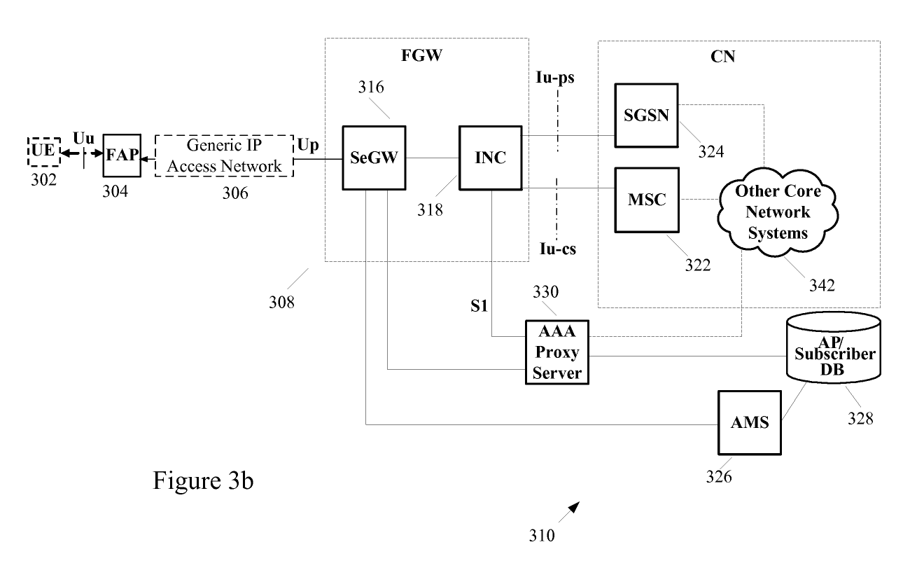

FIGS. 3a and 3b illustrate an integrated communication system (ICS) architecture 300 in accordance with some embodiments of the present invention. FIG. 3a shows a broad overview, with many details omitted for clarity, of an ICS architecture 300 that enables UE 302 to access a CN 310 in one of two ways. First, the UE 302 can access the CN 310 through a licensed wireless connection 313 (e.g., radio links employing radio frequencies within a licensed bandwidth) to Node B 312 (as cell towers are called in the UMTS Terrestrial Radio Access Network (UTRAN) standard of some embodiments). Node B 312 connects to an RNC 314 that connects to the CN 310. Second, the UE 302 can access the CN 310 through a wireless connection that provides an ICS access interface 303 to a FAP 304 that connects to a generic IP access network 306. The generic IP access network 306 connects in turn to an FGW 308. FGWs of various embodiments of FGWs comprise generic access network controllers (GANCs), Radio Access Network (RAN) Gateways, Access Gateways, Access Concentrators, etc. The FGW 308 connects to the CN 310. In some embodiments, the communication session includes voice services, data services, or both.

The licensed wireless connection 313 may comprise any licensed wireless service having a defined UTRAN or Base Station Subsystem (BSS) interface protocol (e.g., Iu-cs and Iu-ps interfaces for UTRAN or A and Gb interfaces for BSS) for a voice/data network. The UTRAN connection typically includes at least one Node B 312 and an RNC 314 for managing the set of Node Bs 312. Typically, multiple Node Bs 312 are configured in a cellular configuration (each Node B serving one cell or multiple cells in proximity to each other) that covers a wide service area.

Each RNC 314 communicates with components of the CN 310 through a standard radio network controller interface such as the Iu-cs and Iu-ps interfaces depicted in FIG. 3b in relation to the FGW 308. For example, a RNC 314 communicates with MSC 322 via a UTRAN Iu-cs interface (not shown) for circuit switched voice services. Additionally, the RNC 314 communicates with SGSN 324 via the UTRAN Iu-ps interface (not shown) for packet data services. However, one of ordinary skill in the art will recognize that in some embodiments, other networks with other standard interfaces may apply. For example, in some embodiments, the RNC 314 in a GSM/GPRS network is replaced with a Base Station Controller (BSC) that communicates voice information to the MSC 322 via an A interface and data to the SGSN 324 via a Gb interface of the GSM/GPRS network.

In the illustrated embodiment, the licensed wireless network depicts components common to a UTRAN, based cellular network that includes multiple base stations referred to as Node Bs 312 (of which only one is shown for simplicity) that facilitate wireless communication services for various UE 302 via respective licensed wireless connection 313. However, one of ordinary skill in the art will recognize that in some embodiments, the licensed wireless network may include other licensed wireless networks such as the GSM/GPRS or GERAN, and that towers (base stations) other then Node B towers may be used.

FIG. 3b provides a more detailed illustration of the part of the system that connects the UE 302 to the CN 310 in some embodiments through the FAP 304. FIG. 3b shows that some embodiments include an AP/Subscriber database 328 which has information specific to the APs (such as the various operating radio parameters, list of UEs allowed to access a given FAP, location of the FAP, etc). Some embodiments include an AAA Server 330

In some embodiments, the functions of the AP/Subscriber database and AAA server are internal functions of the FGW, rather than being performed by separate components. That is, in some embodiments, instead of a AAA server, the functions of the AAA server (e.g. generating the FAP list) are performed by FGW SAC Decision Functions, while the AP/subscriber database functions (e.g. tracks the association between UEs and the lists of FAPs each UE may use) are performed by an AP repository of the FGW. In other embodiments, the functions of the AAA server are internal functions of the AMS. Once authorized, the UE 302 may access the voice and data services of the CN 310. In order to provide such services, the CN 310 includes a mobile switching center (MSC) 322 for providing access to the voice services. Data services are provided for through a Serving GPRS (General Packet Radio Service) Support Node (SGSN) 324. The MSC 322 and the SGSN 324 of some embodiments connect to other core network systems 342.

In some embodiments of the ICS architecture, the UE 302 can also connect to the CN 310 via a second communication network facilitated by the ICS access interface 303 and a FGW 308. In some embodiments, the voice and data services over the ICS access interface 303 are facilitated via a FAP 304 communicatively coupled to a Generic IP network 306. The FAP facilitates short-range licensed wireless communication sessions that operate independent of the licensed communication sessions. When the UE 302 is connected to the CN 310 via the second communication network, the signaling from the UE 302 is passed to the FGW 308, the FGW 308 communicates with components of the CN 310 using a radio network controller interface that is similar to radio network controller interface of the UTRAN described above, and includes a UTRAN Iu-cs interface for circuit switched voice services and a UTRAN Iu-ps interface for packet data services (e.g., GPRS). In this manner, the FGW 308 appears to the UTRAN core network as a traditional UTRAN network element (e.g., the Node B 312 and RNC 314) and is managed and operated as such.

Additionally, in some embodiments, the FGW 308 communicates with other system components of the ICS system through one or more of several other interfaces, such as “Up”, “Wm”, “D′/Gr′”, and “S1”, though one of ordinary skill will understand that there are embodiments where only some, or none, of these interfaces are used and other interfaces can be used in other embodiments. In some embodiments, the UE is connected to the FAP using a standard UMTS air interface i.e. Uu interface. The FAP will perform session management on behalf of the connected UEs with the FGW. The “Wm” interface is the interface of some embodiments between the FGW 308 and the AAA Server 330 for authentication and authorization of the UE 302 into the ICS. Some embodiments use the “S1” interface. In these embodiments, the “S1” interface provides an authorization and authentication interface from the FGW 308 to an AAA server 330. In some embodiments, the AAA server 330 that supports the S1 interface and the AAA server 330 that supports Wm interface are the same. However, as noted above, some embodiments do not have an AAA server as a component, but have the FGW 308 perform the functions that in other embodiments are performed by the AAA server 330, and that any references in this application that refers to an AAA server also disclose an FGW that performs the same functions internally.

In some embodiments, the UE 302 must register with the FGW 308 prior to accessing ICS services. In some embodiments registration is performed by the FAP on behalf of the UE. Registration information of some embodiments includes a subscriber's International Mobile Subscriber Identity (IMSI), a Media Access Control (MAC) address, and a Service Set Identifier (SSID) of the serving access point as well as the cell identity from the GSM or UTRAN cell upon which the UE 302 is already camped. The FGW 308 then passes this information to the AAA server 330 to authenticate the subscriber and determine the services (e.g., voice and data) available to the subscriber. If approved by the AAA 330 for access, the FGW 308 will permit the UE 302 to access voice and data services of the ICS system.

These voice and data services are seamlessly provided by the ICS to the UE 302 through various interfaces. For example, when a UTRAN core network is integrated with the ICS, voice services are provided through the FGW 308 over the standard Iu-cs interface. In some embodiments, FGW 308, FAP 304, UE 302, and the area covered by the FAP 304 are collectively referred to as a Femtocell System.

### II. Individual Components of the Integrated Communication System

A. User Equipment (UE)

In some embodiments, the UE 302 is a standard 3G handset device operating over licensed spectrum of the provider. In some embodiments, the UE includes a cellular telephone, smart phone, personal digital assistant, or computer equipped with a subscriber identity module (SIM) card for communicating over the licensed or unlicensed wireless networks. Moreover, in some embodiments the computer equipped with the SIM card communicates through a wired communication network.

Alternatively, in some embodiments the UE 302 includes a fixed wireless device providing a set of terminal adapter functions for connecting Integrated Services Digital Network (ISDN), Session Initiation Protocol (SIP), or Plain Old Telephone Service (POTS) terminals to the ICS. Application of the present invention to this type of device enables the wireless service provider to offer the so-called landline replacement service to users, even for user locations not sufficiently covered by the licensed wireless network. Moreover, some embodiments of the terminal adapters are fixed wired devices for connecting ISDN, SIP, or POTS terminals to a different communication network (e.g., IP network) though alternate embodiments of the terminal adapters provide wireless equivalent functionality for connecting through unlicensed or licensed wireless networks

B. Femtocell Access Point (FAP)

The FAP 304 is a licensed access point which offers a standard radio interface (Uu) for UE 302 connectivity. The FAP 304 of some embodiments provides radio access network connectivity for the UE 302 using a modified version of the standard Generic Access Network (GAN) interface (Up). In other embodiments, an IP based interface connects the FAP 304 to the FGW 308. In some of these embodiments, the IP based interface facilitates the FAP 308 in appearing to the UE 302 as a base station (e.g. a Node B) of a licensed wireless system. The FAP 304 generates a short-range licensed wireless signal detectable by the UE 302 when within range of the signal generated by the FAP 304. Typically, this range spans a few tens of meters whereas a macrocell typically spans 500 meters to 10 kilometers In other words, the coverage area generated by the FAP is a Femtocell that has a range that is 10, 100, 1000, or more times less than a macro cell of the macro network. To the UE 302, the signal of the FAP 304 appears as a signal from a new cell of the macro network. Therefore, the UE 302 is unable to distinguish the FAP 304 from other Node B's or base stations of the macro network. In some embodiments, the FAP 304 is equipped with either a standard 3G USIM or a 2G SIM.

In accordance with some embodiments, the FAP 304 will be located in a fixed structure, such as a home or an office building. In some embodiments, the service area of the FAP 304 includes an indoor portion of a building, although it will be understood that the service area may include an outdoor portion of a building or campus.

C. Femtocell Access Point Gateway (FGW)

In some embodiments, the FGW appears to the core network as a UTRAN RNC. The FGW of some embodiments includes a Security Gateway (SeGW) 316 and IP Network Controller (INC) 318. Some embodiments have an internal FGW Control Function instead of an INC. Other embodiments have network controllers that are not INCs but perform the same or equivalent function within the system. One of ordinary skill in the art will realize that where this application refers to an INC, an FGW control function or another network controller that performs the same or equivalent functions can be used instead. In some embodiments, the FGW 308 is a GANC that is an enhanced version of the GANC defined in the 3GPP document “Generic access to the A/Gb interface; Stage 2”.

The SeGW 316 provides functions that are defined in industry standards documents TS 43.318 and 44.318. The SeGW 316 terminates secure access tunnels from the FAP 304, providing mutual authentication, encryption and data integrity for signaling, voice and data traffic. The SeGW 316 is required to support EAP-SIM and EAP-AKA authentication for the FAP 304.

In some embodiments, the INC 318 is a core FGW element. The INC is front-ended with a load balancing router/switch subsystem which connects the INC to the other systems; e.g., FGW security gateways, local or remote management systems, etc.

D. Broadband IP Network

The Broadband IP Network 420 represents all the elements that collectively support IP connectivity between the Security Gateway SeGW function and the FAP 304. In some embodiments, this includes: (1) other customer on-site equipment (e.g., DSL/cable modem, WLAN switch, residential gateways/routers, switches, hubs, WLAN access points), (2) network systems specific to the broadband access technology (e.g., DSLAM or CMTS), (3) ISP IP network systems (edge routers, core routers, firewalls), (4) wireless service provider (WSP) IP network systems (edge routers, core routers, firewalls), and (5) network address translation (NAT) functions, either standalone or integrated into one or more of the above systems.

E. AP Management System (AMS)

In some embodiments, the AMS 326 is used to manage a large number of FAPs 304 including configuration, failure management, diagnostics, monitoring and software upgrades. In some embodiments, the functions described as being performed by the AAA are instead internal functions of the AMS. The access to AMS functionality is provided over secure interface via the FGW SeGW 316. In some embodiments, the functions of the AMS are internal functions of the FGW, rather than an AMS being a separate component.

### III. Function of Sub-Systems of the Integrated Communication System

A. FAP Overview

Different embodiments provide different arrangements for connections between FAPs and UEs. Some embodiments use “closed FAPs” in such “closed FAPs” the FAP restricts access to only those UEs that have subscribed to the Femtocell service over that specific FAP. In such embodiments, the UEs can use only specific, associated FAPs. In some embodiments, the UE is associated with a single FAP. In other embodiments, the UE is associated with multiple FAPs. In other embodiments, a FAP operates in an open access mode (open FAPs) where any UE may access the Femtocell functionality through the particular FAP. In some embodiments, open FAPs allow access to any UE however associated or subscribed UEs are given priority. Some embodiments include a mixture of closed and open FAPs. Several embodiments are described in more detail below.

B. Neighbor Configuration

In some embodiments, a macrocell (also known as a UTRAN cell) RNC is configured with 3-5 Femtocell neighbors (e.g. 3-5 Femtocell neighbors provided with 3-5 UARFCN and SC combinations, one combination for each of 3-5 FAPs). Each Femtocell neighbor on the macrocell RNC is represented using Supercell information (one Supercell per UARFCN, SC combination). Supercells allow un-organized FAPs, to be organized into logical cells for the purpose of identification and addressing for the rest of the ISC. A Supercell (sometimes referred to as a “virtual cell”, “logical cell”, “Femto-Supercell” or “conceptual cell”) is a logical cell made up of a collection of Femtocells sharing the same UARFCN, SC combination. There is no requirement that any of the Femtocells making up a particular Supercell be in proximity to each other. Nor will a FAP necessarily be allocated to the same Supercell each time it is activated. In embodiments with a mix of open as well closed FAPs, different Supercells (e.g. using different UARFCN, SC combinations) can be used to distinguish the open FAP from the closed FAPs.

C. FAP Configuration

Each FAP 304 is pre-allocated, upon power-up and successful registration, with either a pool of shared hand-in channels (SHC) or pool of global hand-in channels (GHC). These channels are transitional channels that are used while the UE is being handed in from a macrocell to a FAP. Once the hand-in is complete, the UE 302 and FAP 304 communicate using channels selected during the hand-in and the GHC or SHC channels used during the hand-in are released to permit additional hand-ins from other UEs. The number of SHCs or GHCs in the pool will determine the maximum number of outstanding hand-ins that can be supported system wide per INC 318 (or in some embodiments per FGW 308) at any given time.

The UE uses the channel information to reconfigure its physical channels during hand-in from a macrocell to a Femtocell. The channels in the SHC pool, although pre-allocated, are not enabled until handover access grant is indicated by the serving FGW (as a result of successful network service access control). On the other hand the GHC pool, which is also pre-allocated, is always enabled on every FAP 304. In some embodiments, additional logic for the use of SHC vs. GHC can be done by utilizing the FAP's operational mode of either closed FAP or open FAP.

D. Single Closed FAP Connectivity

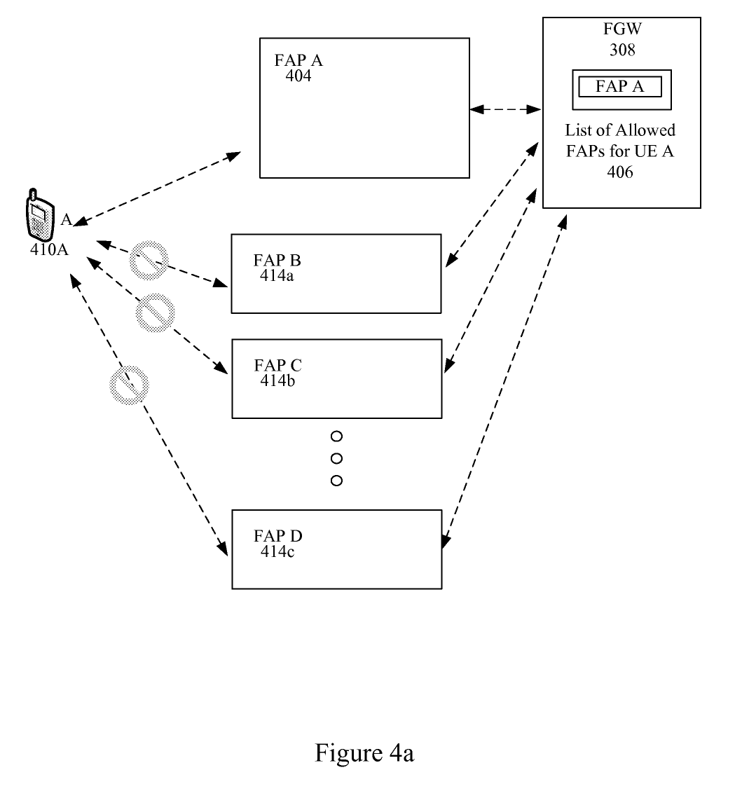

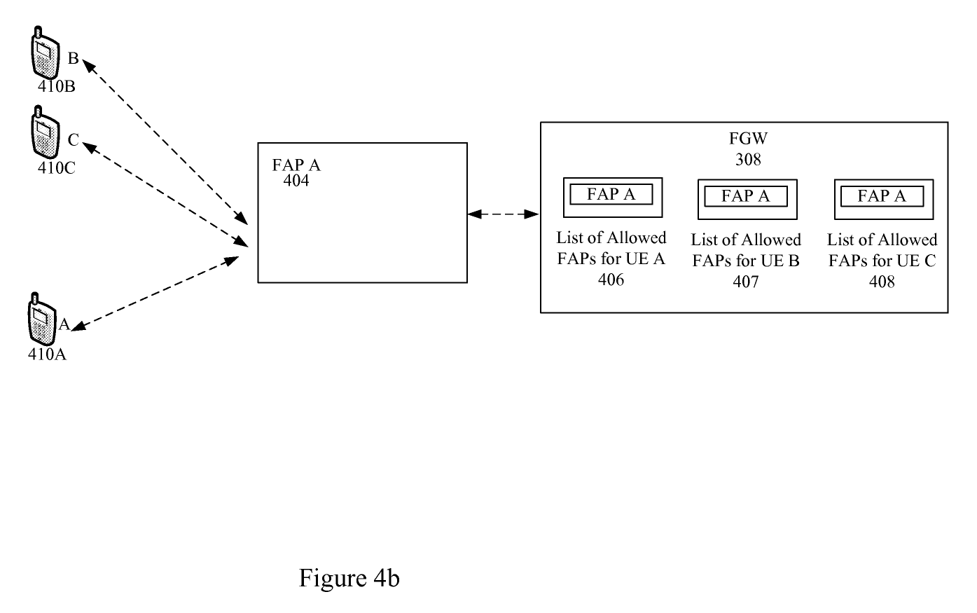

Some embodiments provide a UE with a single closed FAP. A UE with a single closed FAP is only able to use that particular FAP and no other. FIG. 4a illustrates a system in which a UE 410A can only use a single closed FAP, FAP A 404. In the figure, the UE 410A is shown as being allowed to connect to FAP A 404 because the FGW 308 has that FAP on a list of FAPs to which UE 410A is allowed to connect. UE 410A is not allowed to connect to FAP B, FAP C, or FAP D 414a-c or any other (not shown) FAPs because those FAPs are not on the list of allowed FAPs for UE 410A. Although FIG. 4a shows the FAP list as being in the FGW 308, in some embodiments, the FGW retrieves the allowed FAP list from an AAA server 330. In some embodiments, the allowed FAP list is retrieved from some other part of the network.

In an embodiment with a single closed FAP, the allowed FAP list for a UE has only one FAP in it. However, it will be clear to one of ordinary skill that in some embodiments, while each UE may only be allowed to connect to a single particular FAP, that multiple UEs may be allowed to use the same FAP. This is illustrated in FIG. 4b. The figure shows that the FGW 308 has a list of allowed FAPs 407 for UE B 410B and a list of allowed FAPs 408 for UE C 410C. Each of these lists is a single FAP long. However the single FAP on each list is the same FAP A.

In some embodiments where the UE 404A is only allowed to communicate with a single FAP 404, the FAP does not require pre-allocated channels (SHCs or GHCs) for hand-ins, but instead can use a dedicated channel for the given UE 404A. Dedicated channels are used on demand and are not pre-allocated. In these embodiments, when the hand-in is requested, the target FAP allocates specific resources for the hand-in.

E. Multiple Closed FAP Connectivity

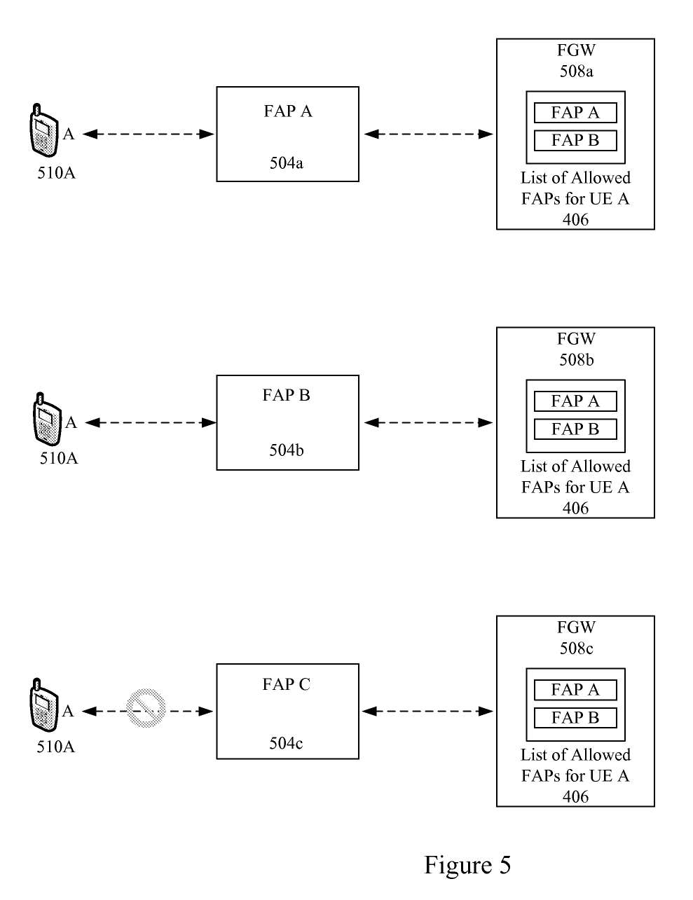

Some embodiments provide a UE with a multiple closed FAPs. A UE with multiple closed FAPs is only able to use those particular FAPs and no other. FIG. 5 illustrates a system in which a UE 510A can only use two closed FAPs, FAP A 504a and FAP B 504b. In the figure, the UE 510A is shown as being allowed to connect to FAP A 504a and FAP B 504b because the FGW 508a has those FAPs on a list of FAPs to which UE 510A is allowed to connect. UE 510A is not allowed to connect to FAP C 504c or any other (not shown) FAPs because those FAPs are not on the list of allowed FAPs for UE 510A. The FGWs 508a-c are shown as separate FGWs because in some implementations of some embodiments, the authorized FAPs are in separated locations, such as at an office and a home. In some embodiments, different geographical locations may be served by different FGWs. However, in some implementations, multiple authorized FAPs may use the same FGW.

In an embodiment with multiple closed FAPs, the allowed FAP list for a UE has multiple FAP in it. It will be clear to one of ordinary skill that in some embodiments, while each UE may only be allowed to connect to a set of particular FAPs, that multiple UEs may be allowed to use the same FAP. This is similar to the case illustrated in FIG. 2b, but with multiple FAPs on a list instead of one FAP on a list.

In some embodiments with multiple-closed FAPs, the FAPs use SHCs for the hand-in process. In the course of handing over the UE from a macrocell to a FAP, a channel is assigned for the given UE 504A and the SHCs are released to perform more hand-ins.

F. Open FAP Connectivity

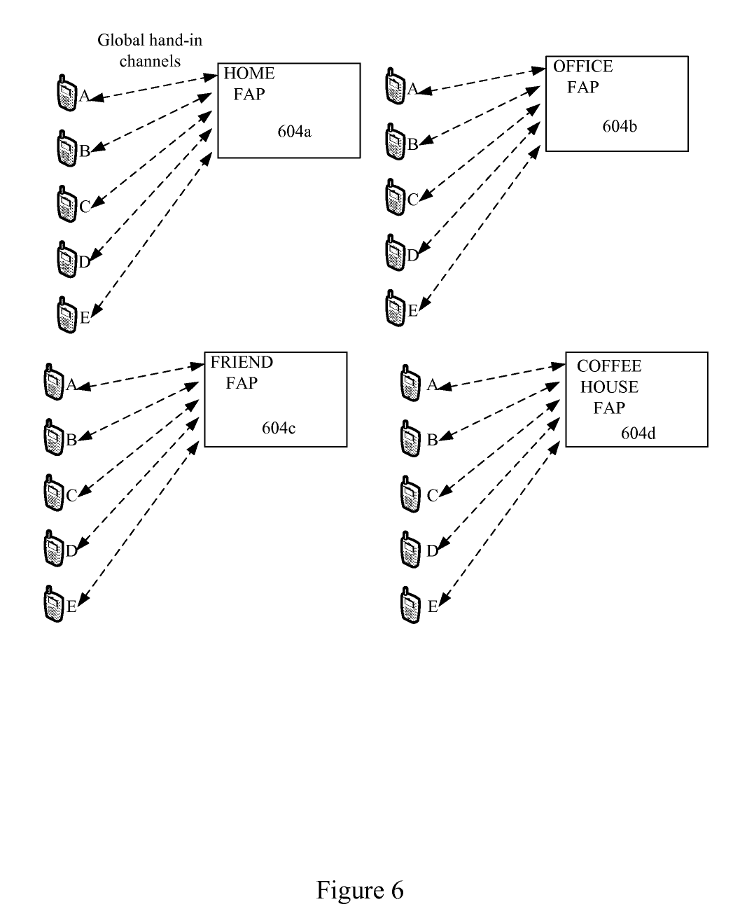

Some embodiments provide a UE with open FAPs. A UE with open FAPs is able to use any open FAPs. FIG. 6 illustrates a system in which multiple UEs can all connect to any open FAPs 604a-d.

G. FAP Geographical Representation

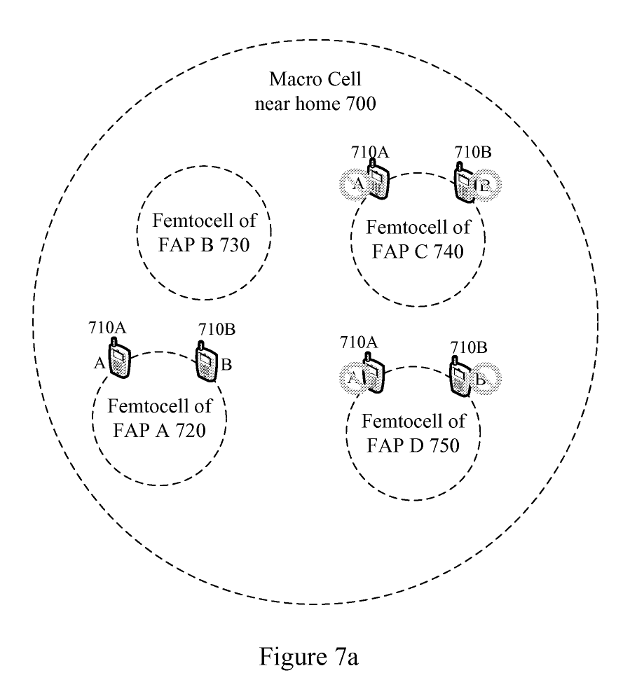

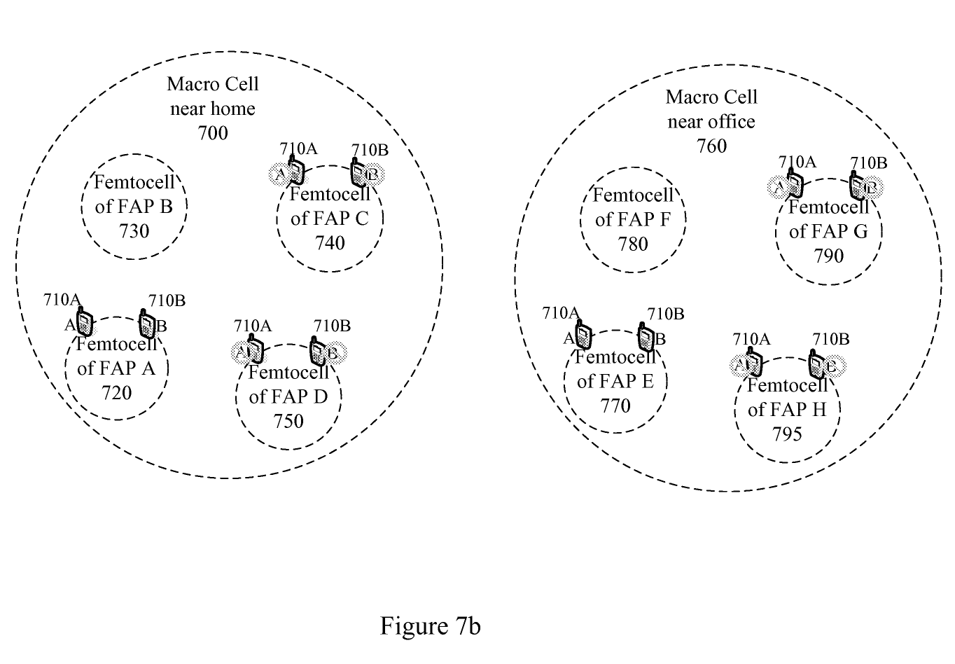

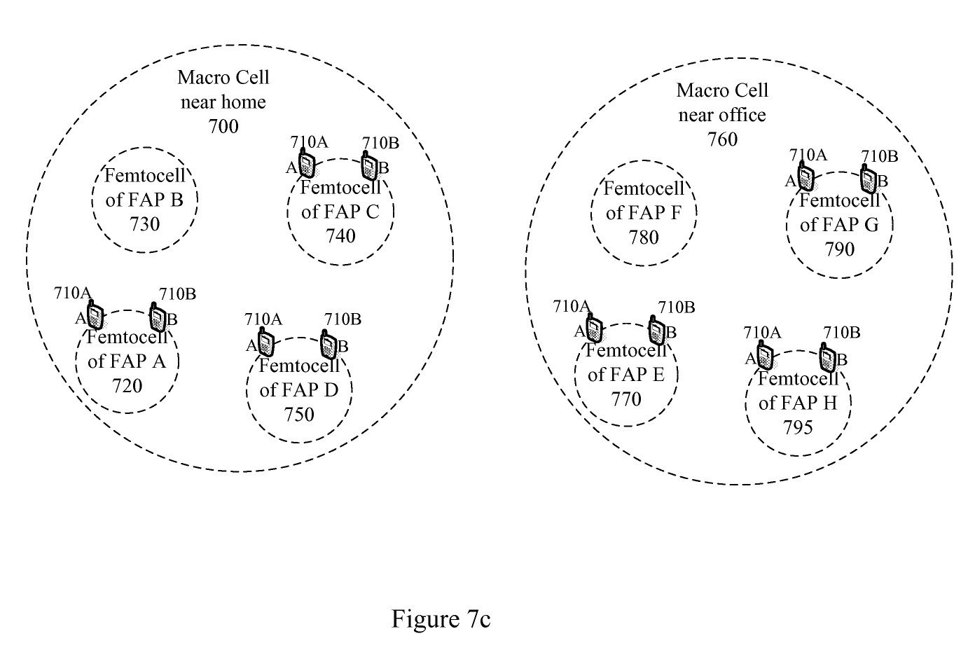

FIG. 7a illustrates the geographical scope of a single closed FAP system of some embodiments. Here, a macrocell 700 near the home of the owners of UE 710A and 710B has 4 Femtocells within its range, 720, 730, 740, and 750. As shown, UEs 710A and 710B are sometimes within range of Femtocell 720 (their authorized Femtocell) and sometimes in range of Femtocells 740 and 750. As indicated in the figure UE 710A and 710B are never in range of Femtocell 730, so the problem of whether or not Femtocell 730 is authorized never arises. When the UEs 710A and 710B are in range of Femtocell 720 ongoing calls on the UEs 710A and 710B are handed over to the Femtocell 720. When the UEs 710A and 710B are in range of Femtocells 740 and 750, the ongoing calls are not handed over.

FIG. 7b illustrates the geographical scope of a multiple closed FAP system of some embodiments. Here, again, a macrocell 700 near the home of the owners of UE 710A and 710B contains 4 Femtocells, 720, 730, 740, and 750. UEs 710A and 710B are sometimes within range of Femtocell 720 (their authorized Femtocell) and sometimes in range of Femtocells 740 and 750. When the UEs 710A and 710B are in range of Femtocell 720 ongoing calls on the UEs 710A and 710B are handed over to the Femtocell 720. When the UEs 710A and 710B are in range of Femtocells 740 and 750, the ongoing calls are not handed over. This is similar to the geographical scope of the single closed FAP system. However, in the multiple closed FAP system a second FAP, that of Femtocell 770 is on the allowed list for UEs 710A and 710B. The macrocell 760 is near the office of the owners of UEs 710A and 710B, and the macrocell 760 contains the allowed FAP of Femtocell 770, and also non-allowed FAPs 780, 790, and 795. As shown in the figure, the UEs 710A and 710B can be handed over to FAPs 720 and 770, but not to other FAPs.

FIG. 7c illustrates the geographical scope of an open FAP system of some embodiments. Here, the UEs 710A and 710B can use any of the open FAPs 720-750 and 770-795, so long as they come in range of the FAPs.

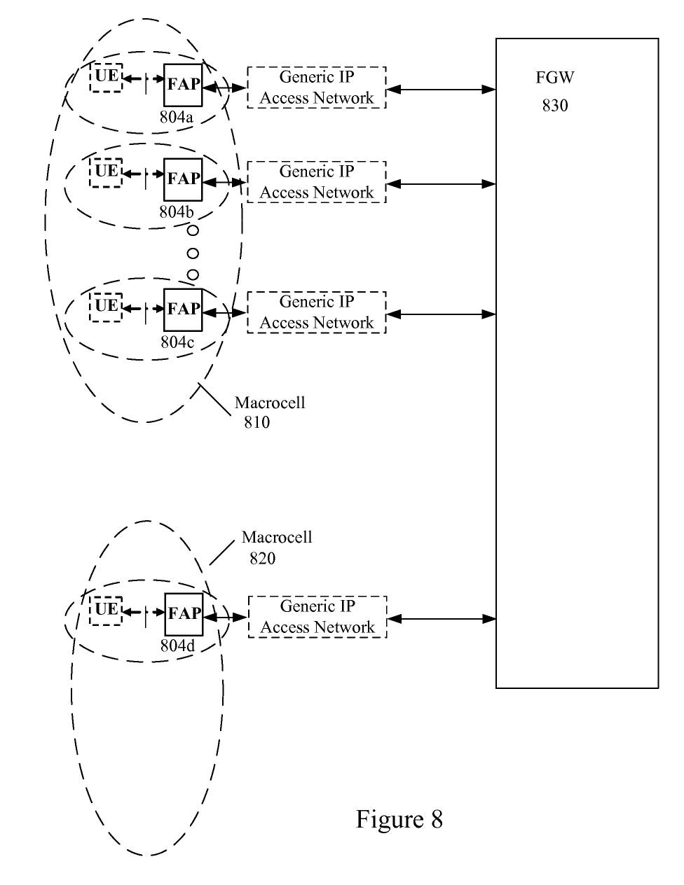

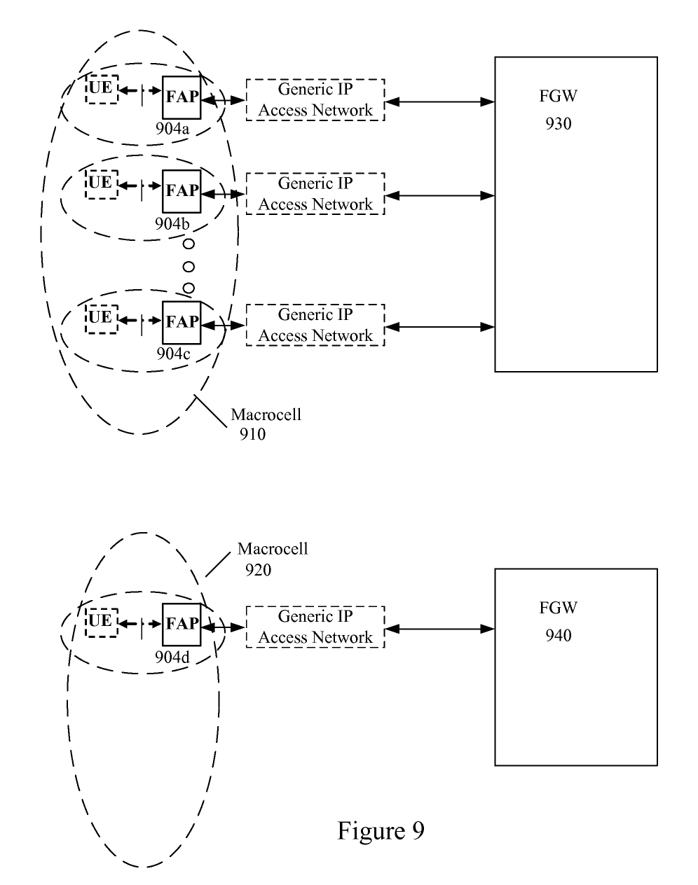

FIG. 8 illustrates that FAPs 804a-d within different macrocells, 810 and 820 can be serviced by (e.g. connected to the larger phone system through) the same FGW 830. There does not have to be a separate FGW for each FAP or even for each macrocell. FIG. 9 illustrates that FAPs 904a-d from different macrocells 910 and 920 can also be serviced by different FGWs 930 and 940. There can be multiple FGWs serving multiple macrocells in a cellular system that includes FAPs.

### IV. Messaging for Call Hand-in

A. Single Closed FAP Messaging

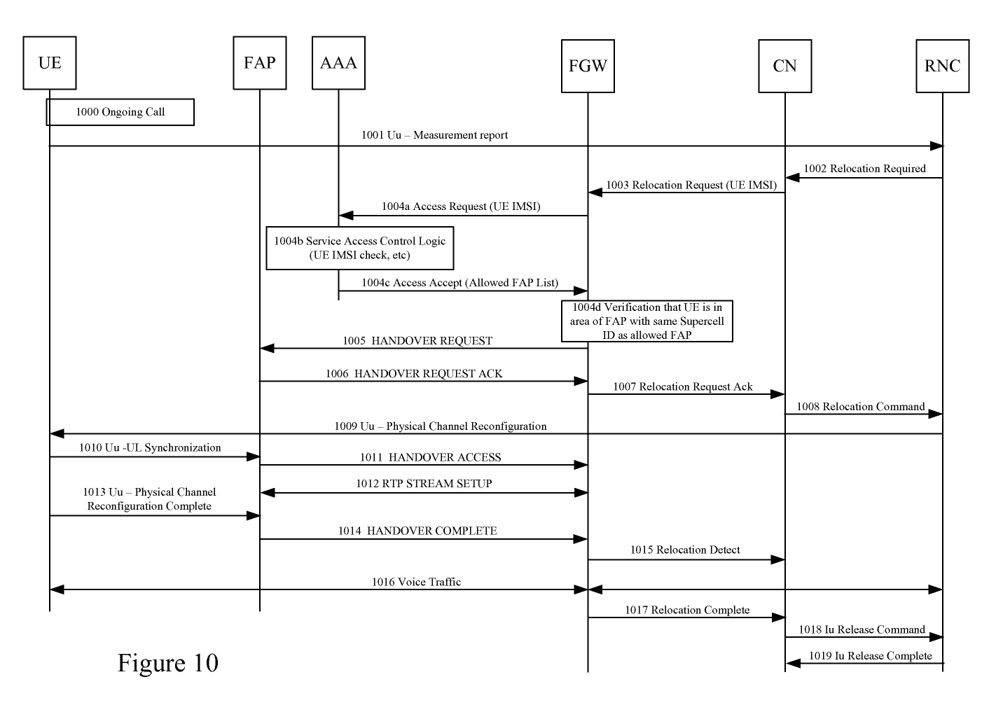

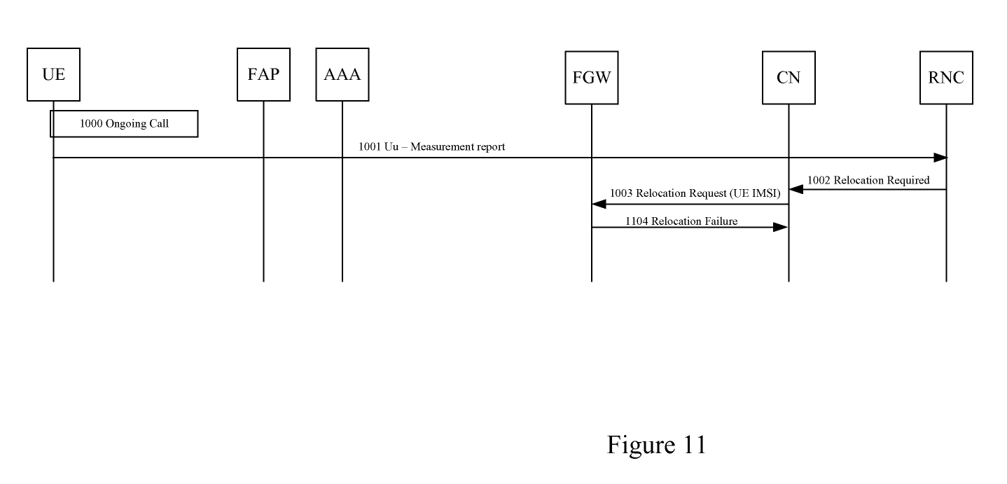

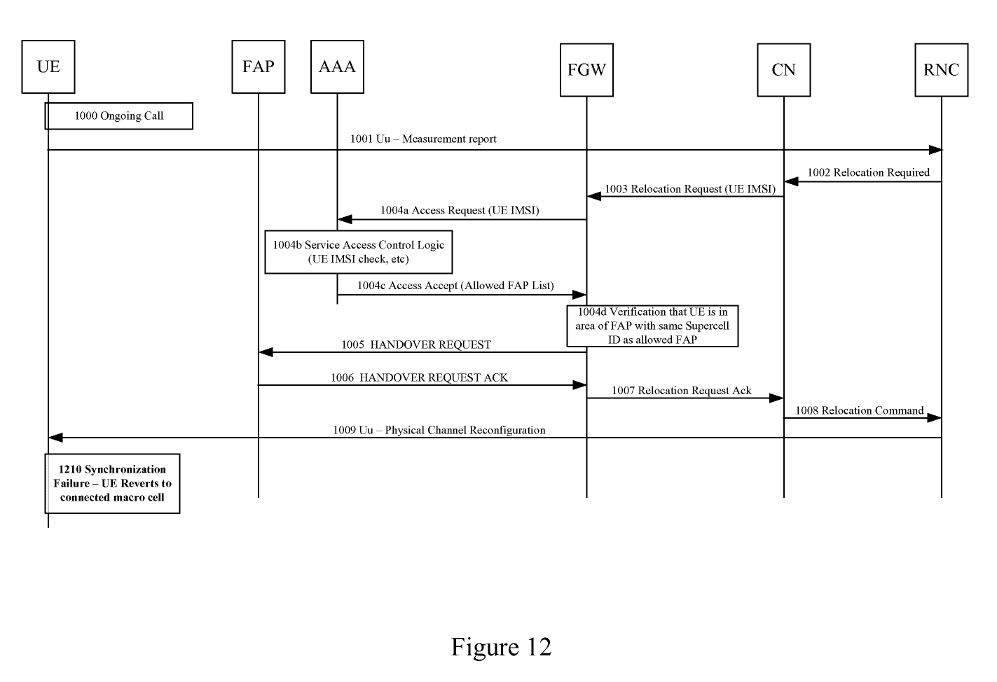

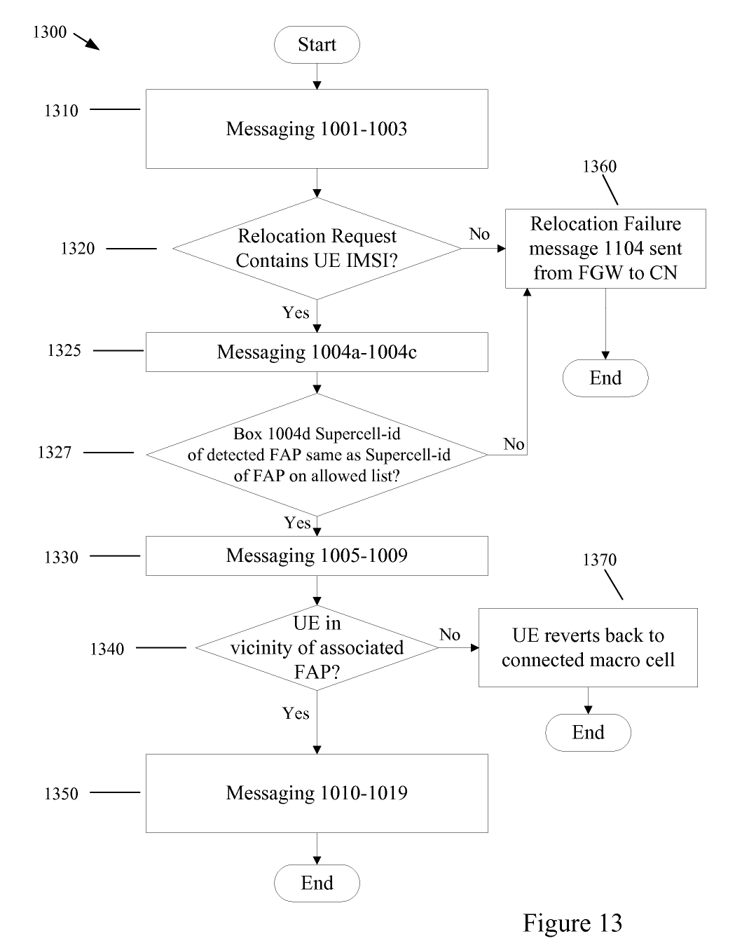

FIGS. 10-12 illustrate the messaging for a hand-in method of a single closed FAP of some embodiments. Some embodiments use GAN messages (e.g. GA-CSR, GA-PSR, GA-RRC messages); other embodiments use Radio Access Network Application Part (RANAP) or IP Multimedia Subsystem (IMS) messages. It will be clear to one of ordinary skill in the art that the message names provided are examples, and that other embodiments may use other message names. For example, some embodiments may refer to messages that in this application use the word “Handover” as using the word “Relocation” instead, e.g. “Handover request” is replaced in some embodiments with “Relocation request”. FIG. 10 illustrates messaging for a successful hand-in of some embodiments. FIGS. 11-12 illustrate the messaging for a failed hand-in of some embodiments. The messaging of FIGS. 10-12 are described below in relation to the flowchart of FIG. 13.

The flowchart of FIG. 13 aggregates messages that do not have branching decision points. The various boxes of the flowchart will be described as the messages in the successive figures are explained. For the description of the UTRAN to Femtocell Handover procedure (i.e. hand-in), the following conditions exist in the embodiments described in this section: (1) the UE is on an active call on the UTRAN, (2) the UE has been ordered by the RNC to make intra- or inter-frequency measurements, (3) the UTRAN provides information on neighboring cells such that one of the cells in the neighbor list matches the cell associated with the FAP, as provided in the AS-related component of the system information, and (4) the UE is associated with a single FAP for Femtocell services. One of ordinary skill in the art will realize that some embodiments use inter-frequency measurements, while in some embodiments, intra-frequency measurements can be used instead of or in addition to inter-frequency measurements.

A voice, data, or combined (e.g. Multi Radio Access Bearer (multi-RAB)) call 1000 is ongoing when the messaging process 1300 of FIG. 13 starts. As shown in FIG. 13, this process initially sends (at 1310) three messages. The first message is a Measurement Report message 1001 from the UE to the RNC. With this message, the UE begins to include information about a FAP cell in its vicinity. Based on the UE measurement reports and other internal algorithms, the RNC decides to initiate handover to the target cell indicated in the measurement report, and sends the second message. The decision to initiate handover in some embodiments is based on the proximity of the UE to a FAP cell which is not necessarily a FAP cell it is authorized to use. Later messaging deals with that possibility.

The second message is a Relocation Required message 1002 from the RNC to the CN. With this message, the RNC starts the preparation phase of the Relocation procedure by identifying (though not uniquely identifying) the target Femtocell using the Supercell for the {UARFCN, SC} pair. In some embodiments, the Source RNC provides a target-id in the relocation message to the CN. The CN routes the messages based on the supplied target-id. The target-id is configured as a neighbor attribute in the macro network and is always available independent of the access type i.e. closed/open or single/multiple FGW. In some embodiments, multiple FGW are used in large scale deployment.

Then the third message is sent. The third message is a Relocation Request message 1003 from the CN to the FGW. With this message, the CN requests that the target FGW (based on the target RNC-id information in the Relocation Required message 1002 from the RNC) allocate resources for the handover.

Once these three messages are sent (at 1310), the FGW determines (at 1320) whether the Relocation Request message 1003 contains a UE IMSI. This is a branching point in the flow of messages. If the Relocation Request message 1003 does not contain a UE IMSI, then a Relocation Failure message 1104 is sent (at 1360) from a FGW to the CN and the hand-in process ends in failure, as shown in FIG. 11. After a rejected handover, the ongoing call will remain on the macrocell, rather than switching to the Femtocell. If the Relocation Request message 1003 from the CN does contain the UE IMSI, the method will proceed as below in some embodiments.

If the Relocation Request message 1003 does contain a UE IMSI, then Access Request message 1004a is sent (at 1325) from the FGW to the AAA server. The AAA then uses Service Access Control Logic 1004b to determine an allowed FAP list for the UE. Then an Access Accept message 1004c containing the allowed FAP list is sent from the AAA to the FGW. In some embodiments, instead of a separate AAA server, the FGW has an internal SAC decision function that generates a FAP list based on the association between the UE and the FGW. In some embodiments, the determination of allowed FAPs is based on the UE IMSI provided in the Relocation Request message 1003 from the CN and the FGW performs service access control (SAC) over an S1 interface. In some embodiments, the SAC logic returns the specific single FAP IMSI associated with the UE.

In some alternate embodiments, the FGW performs (at 1327) the Supercell-id verification of box 904d, to minimize handover failure due to enabling of SHC (or allocation of dedicated resources for the single FAP access case of some embodiments) on incorrect FAP locations (e.g. the UE is not actually in the vicinity of the allowed FAP). The Supercell-id verification will ensure that the UE is in the same Supercell as a FAP on the allowed list (in some embodiments this is the FAP requested by the source RNC via a “target Cell-Id” attribute). The Supercell-id verification of some embodiments acts as a filter to reduce the number of handover failures later in the process. For example, in a closed FAP system in which every FAP is assigned to one of five Supercells, a determination that the FAP the UE is sending measurement reports about, is in Supercell one, while the FAP on the UE's allowed FAP list is in Supercell two, means that the FAP the UE is sending measurement reports about, is not the FAP that it is authorized to use. At that point the FGW of some embodiments sends a relocation failure message, similar to the Relocation Failure message 1104 shown in FIG. 11, to the core network.

In contrast, if the FAP the UE is near is in Supercell one, and the FAP on the allowed FAP list is also in Supercell one, that does not necessarily mean that the FAP that the UE is near is the one on the allowed FAP list. However, such Supercell-id verifications cut down the average number of handover procedures that proceed past this point by a factor of n, where n is the number of Supercells (in some embodiments n is the number of Supercells covering the same area). The Supercell-id (i.e. the target cell-id) configuration on the macro RNC and verification on the FGW may be also achieved via one of the other mechanisms described in the section on Supercells below.

If the conditions for handover described above are met (e.g. the Relocation Request message 1003 does contain the UE IMSI and the UE is in the vicinity of the associated FAP), then, the messaging process 1300 sends (at 1330) the next five messages. The first message is a HANDOVER REQUEST message 1005 from the FGW to the FAP. The message is sent to the associated FAP using the FAP IMSI information provided by the SAC logic. At this point, the FGW will also send the relevant integrity and ciphering information to the target FAP, and the FAP sends the second message. The second message is a HANDOVER REQUEST ACK (acknowledgement) message 1006 from the FAP to the FGW. The FAP also sends information necessary for physical channel reconfiguration of the UE on that FAP cell.

The third message, a Relocation Request Acknowledge message 1007, is then sent from the FGW to the CN. The third message acknowledges the handover request message, indicating it can support the requested handover, and includes a Physical Channel Reconfiguration message that indicates the radio channel to which the UE should be directed. The fourth message, a Relocation Command message 1008, is sent from the CN to the RNC. This message completes the relocation preparation and orders that the relocation itself be started. The fifth message, a Physical Channel Reconfiguration message 1009, is then sent from the RNC to the UE. This message initiates handover to the Femtocell. The UE does not switch its audio path (e.g. voice communications) from UTRAN to the Femtocell until handover completion.

Once the preceding five messages have been sent, the messaging process 1300 determines (At 1340) whether the UE is in the vicinity of the associated FAP. This is another branching point in the flow of messages. If the UE is not in the vicinity of the associated FAP, then the uplink synchronization to the target FAP will fail since the physical channel information returned by the FGW is relevant only for the associated FAP. This will serve as an implicit SAC on the target FAP. A failure of a non-associated FAP to establish the physical channel will result in UE reverting back to the connected macro cell, as shown in box 3110 of FIG. 12. In some embodiments the UE will revert using procedures as described in industry standards document TS25.331, “Radio Resource Control (RRC) protocol specification”

If the UE is in the vicinity of the associated FAP, then the next message is sent (at 1350). The next message is a Uu-UL Synchronization message 1010 from the UE to the FAP. This message allows the UE to perform a handover into the new cell via uplink synchronization to the target FAP on the Uu interface.

Once the preceding message is sent, the messaging process 1300 proceeds (also at 1350) to send the next nine messages. The first message of this set is a HANDOVER ACCESS message 1011 from the FAP to the FGW. The contents of the message allow the FGW to correlate the handover to the Relocation Request Acknowledge message 1007 sent earlier by the FGW to the CN and identify the successful completion of the handover. In some embodiments, in order to minimize the time needed to setup the control path for the UE handover (creation of UE specific TCP session and registration of the UE with the FGW), the HANDOVER ACCESS message 1011 can be exchanged over the existing FAP TCP session.

At this point, the second message, a RTP STREAM SETUP message 1012 is sent between the serving FGW and the FAP. This messaging sets up a bearer path for the FAP and the UE. The third message, a Physical Channel Reconfiguration Complete message 1013, is sent from the UE to the FAP upon completion of synchronization of the UE with the target FAP. The UE uses this message to signals completion of handover. In some embodiments, this message is sent over the Uu interface. In some embodiments, it is possible for the FAP to receive this message prior to messages 1011 and 1012. If the message is received early, the FAP must buffer the message until after messages 1011 and 1012. After message 1013, the fourth message, a HANDOVER COMPLETE message 1014, is sent from the FAP to the FGW. In this message, the FAP indicates that as far as the FAP is concerned, the handover procedure is finished. The fifth message, a Relocation Detect message 1015 is then sent from the FGW to the CN. The message indicates that the FGW has detected the UE. The CN can optionally now switch the user plane from the source RNC to the target FGW.

The sixth “message”, is the bi-directional voice traffic 1016 now flowing between the UE and CN, via the FGW. In some embodiments, this is ongoing and does not stop simply because the next message is sent. The seventh message, a Relocation Complete message 1017, is sent from the FGW to the CN. With this message, the target FGW indicates the handover is complete. If it has not done so before, the CN now switches the user plane from source RNC to target FGW. The eighth message, an Iu Release Command message 1018, is sent from the CN to the RNC. Using this message, the CN tears down the connection to the source RNC. The ninth message of this set, an Iu Release Complete message 1019, is sent from the RNC to the CN. This message from the source RNC confirms the release of UTRAN resources allocated for this call.

B. Closed FAPS and a Given UE is Associated with Multiple FAPS

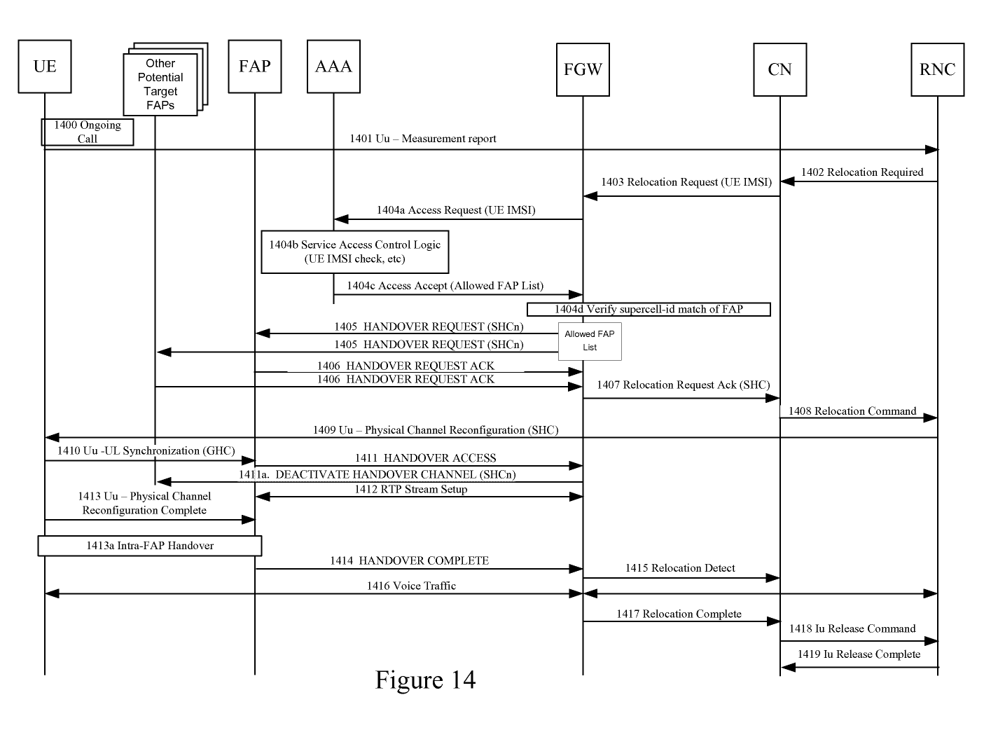

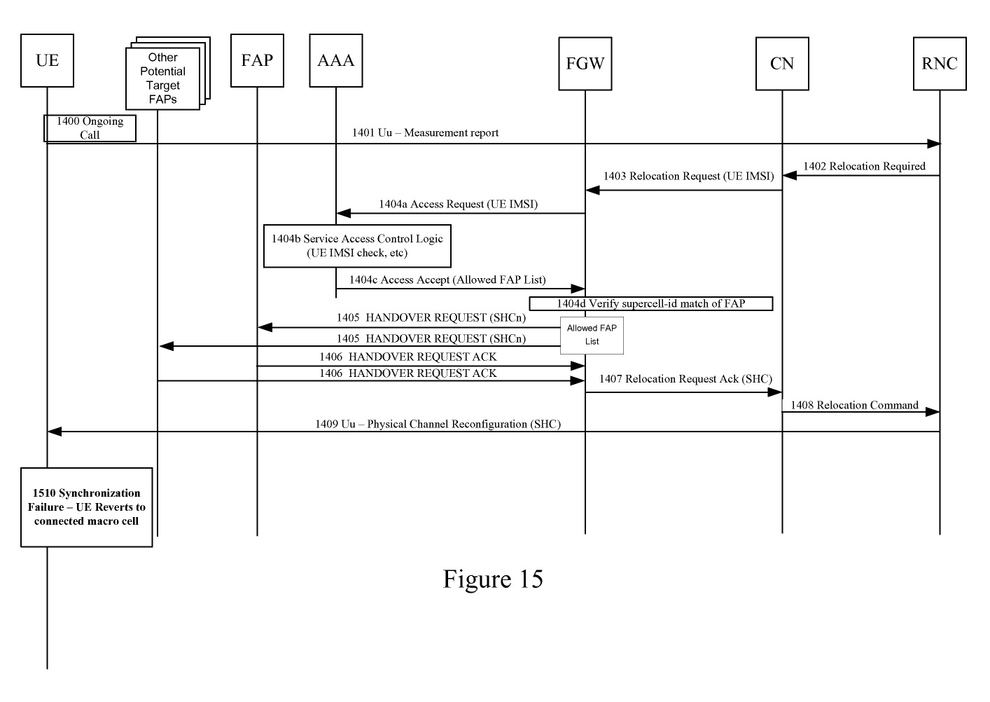

FIG. 14 illustrates messaging for hand-in of some embodiments. FIG. 15 illustrates the messaging for a failed hand-in of some embodiments. In the embodiments described in this section, for the description of the UTRAN to Femtocell Handover procedure (i.e. hand-in), the following conditions exist: (1) the UE is on an active call on the UTRAN, (2) the UE has been ordered by the RNC to make intra- or inter-frequency measurements, (3) the UTRAN provides information on neighboring cells such that one of the cells in the neighbor list matches the cell associated with the FAP, and (4) the UE is associated with a multiple FAPs for Femtocell services.

While a voice, data, or combined voice and data call 1400 is ongoing, the UE begins to include information about a FAP cell in the Measurement Report message 1401 sent to the RNC. Based on UE measurement reports and other internal algorithms, the RNC decides to initiate handover to the target cell indicated in the measurement report. The RNC starts the preparation phase of the Relocation procedure by sending a Relocation Required message 1402 to the CN, identifying (though not uniquely identifying) the target Femtocell using the Supercell for the {UARFC, SC} pair. The CN requests the target FGW (based on the target RNC-id information in the Relocation Required message from the SRNC) to allocate resources for the handover, using the Relocation Request message 1403.

Based on the UE IMSI provided in the Relocation Request message 1403 from the CN, the FGW performs SAC over an S1 interface. The SAC logic 1404b returns a list of FAP IMSIs associated with the UE in Access Accept message 1404c. This is a branching point in the flow of messages. If the Relocation Request 1403 from the CN does not contain the UE IMSI and if the operator has policy for closed FAPs, the FGW will reject the handover by sending a Relocation Failure message 1104 to the CN, as seen in FIG. 11.

After a rejected handover, the ongoing call will remain on the macrocell, rather than switching to the Femtocell. If the Relocation Request from the CN does contain the UE IMSI, the method will proceed with further handover related messaging. In addition, the FGW will perform a Supercell-id verification to minimize handover failure due to enabling of SHC on incorrect FAP locations (e.g. the UE may not be in the vicinity of any of the allowed FAPs). The Supercell-id verification will ensure that the UE is in the same Supercell as that requested by the source RNC via the “target Cell-Id” attribute. The Supercell-id (i.e. the target cell-id) configuration on the macro RNC and verification on the FGW may be achieved via one of the mechanisms as described in the section on Supercells below. In some embodiments, the FGW checks at 1404d whether the UE is in the area of a FAP with the same Supercell-id as a FAP it is authorized to use. If the UE is not in such an area, the handover fails at this point.

At this point, the target FGW sends a HANDOVER REQUEST message 1405 to the associated FAPs (using the FAPs IMSI information provided by the SAC logic). Some embodiments send this message to multiple associated FAPs as the identity of the actual FAP that the UE is near is not known at this point. The UE could be near any of the associated FAPs or none of the associated FAPs. As it is unknown, the FGW sends this request to all associated FAPs, or in other embodiments, to all associated FAPs not ruled out by the Supercell-ids. For the sake of illustrating the messaging functions, the messaging diagram of FIG. 4 assumes that the FAP of the diagram is the associated FAP that the UE is near (if any) and the other associated FAPs are the other potential target FAPs. The HANDOVER REQUEST message 1405 contains information about the SHC channel to be utilized for the given UE's hand-in on the potential list of associated FAPs. Additionally, the FGW will also send the relevant integrity and ciphering information to the list of FAPs. Upon receiving the SHC channel information in the HANDOVER REQUEST message 1405, the allowed FAP will enable the specific SHC (for a fixed period of time) and allow the given UE on the SHC. The FAPs, including the other potential target FAPs, acknowledge the enabling of the SHC and respond(s) with a HANDOVER REQUEST ACK message 1406 to the FGW. The target FGW acknowledges the handover request message, by sending a Relocation Request Acknowledge message 1407 to the CN, indicating it can support the requested handover. The FGW includes a Physical Channel Reconfiguration message that indicates the radio channel (i.e. SHC) to which the UE should be directed. The CN sends the Relocation Command message 1408 to the RNC, completing the relocation preparation and ordering that the relocation itself be started.

At this point, the RNC sends the PHYSICAL CHANNEL RECONFIGURATION message 1409 to the UE to initiate handover to the Femtocell. The UE does not switch its audio path (e.g. voice communications) from UTRAN to the Femtocell until handover completion. The UE performs a handover into the new cell via uplink synchronization (using the provided SHC) to the target FAP on the Uu interface; this is done by sending a Uu-UL synchronization message 1410 to the FAP. This is another branching point in the flow of messages. If the UE is not in the vicinity of any associated FAP(s), then the uplink synchronization to the target FAP will fail since the physical channel information returned by the FGW (SHC) is enabled only for the associated FAP(s). This will serve as an implicit SAC on the target FAP list. A failure of a non-associated FAP to establish the physical channel will result in UE reverting back to the connected macro cell, as shown in box 1510 of FIG. 15. In some embodiments, the UE will revert using procedures as described in industry standards document TS25.331. If the UE is in the vicinity of an associated FAP, the method will proceed as described below.

The FAP sends the HANDOVER ACCESS message 1411 to the FGW. The contents of the message allow the FGW to correlate the handover to the Relocation Request Acknowledge message 1407 sent earlier by the FGW to the CN and identify the successful completion of the handover. In some embodiments, in order to minimize the time needed to setup the control path for the UE handover (creation of UE specific TCP session and registration of the UE with the FGW), the HANDOVER ACCESS message 1411 can be exchanged over the existing FAP TCP session. At 1411a, once the FGW receives HANDOVER ACCESS from the actual target FAP, the FGW sends a DEACTIVATE HANDOVER CHANNEL message 1411a to the remaining other potential target FAPs on the allowed list to deactivate the current SHCs so that the SHCs may be reused for another hand-in. If the remaining FAPs do not receive an explicit deactivate message from the FGW, the SHCs are deactivated automatically after the expiration of the fixed time (in some embodiments, this time is relative to the sending of message 1406 above). At 1412, the serving FGW sets up a bearer path with the FAP and the UE by sending RTP Stream Setup messages 1412 in both directions.

Upon completion of synchronization with the target FAP, the UE signals completion of handover using the Physical Channel Reconfiguration Complete message 1413 over the Uu interface. In some embodiments, it is possible for the FAP to receive this message prior to messages 1411, 1411a and 1412. If the message is received early, the FAP must buffer the messages until after messages 1411, 1411a and 1412. In some embodiments, as illustrated by box 1413, the FAP will then initiate an intra-FAP handover and switch the physical resources to a dedicated channel (DCH), thus releasing the SHC to be utilized for later hand-ins (if any).

The FAP then transmits a HANDOVER COMPLETE message 1414 to indicate that as far as the FAP is concerned, the handover procedure is finished. The FGW indicates to the CN that it has detected the UE, using Relocation Detect message 1415. The CN can optionally now switch the user plane from the source RNC to the target FGW.

Bi-directional voice traffic 1416 is now flowing between the UE and the CN, via the FGW. The target FGW indicates the handover is complete, using the Relocation Complete message 1417. If it has not done so before, the CN now switches the user plane from the source RNC to the target FGW. The CN tears down the connection to the source RNC, using an Iu Release Command message 1418. The source RNC confirms the release of UTRAN resources allocated for this call, using an Iu Release Complete message 1419.

C. Open FAPs

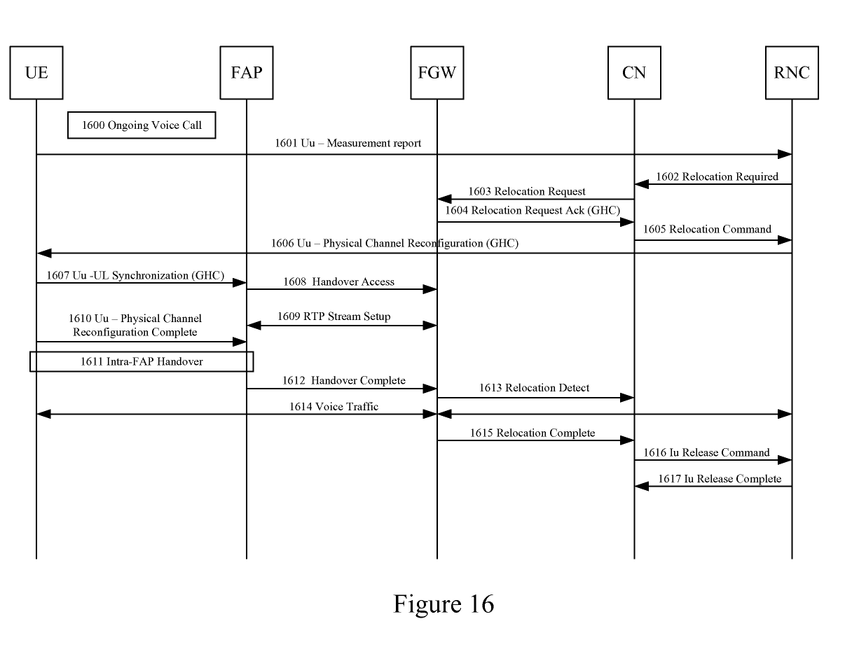

FIG. 16 illustrates messaging for hand-in of some embodiments. In the embodiments described in this section, for the description of the UTRAN to Femtocell Handover procedure (i.e. hand-in), the following conditions exist: (1) the UE is on an active call on the UTRAN, (2) the UE has been ordered by the RNC to make intra- or inter-frequency measurements, (3) the UTRAN provides information on neighboring cells such that one of the cells in the neighbor list matches the cell associated with the FAP, as provided in the AS-related component of the system information obtained from associated serving FGW, (4) the FAPs have an open access policy for Femtocell services and SAC is not enforced on any FAP.

While a voice, data, or combined voice and data call 1600 is ongoing, the UE begins to include information about FAP cell in the Measurement Report message 1601 sent to the RNC. Based on the UE measurement reports and other internal algorithms, the RNC decides to initiate handover to the target cell indicated in the measurement report. The RNC starts the preparation phase of the Relocation procedure by sending a Relocation Required message 1602 to the CN, identifying the target Femtocell using the Supercell for the {UARFCN, SC} pair. The CN requests that the target FGW (based on the target RNC-id information in the Relocation Required message from the SRNC) allocate resources for the handover, using the Relocation Request message 1603.

Since the FAPs of these embodiments have an open access policy each FAP has a GHC reserved and enabled (e.g. pre-allocated) to support hand-in of any UE in the vicinity. As a result of this pre-allocation, the target FGW is not required to find the target FAP for the physical channel information. The target FGW acknowledges the handover request message, using Relocation Request Acknowledge message 1604, indicating it can support the requested handover, and including a Physical Channel Reconfiguration message that indicates the radio channel (i.e. GHC) to which the UE should be directed.

The CN sends the Relocation Command message 1605 to the RNC, completing the relocation preparation. The RNC then sends the PHYSICAL CHANNEL RECONFIGURATION message 1606 to the UE to initiate handover to Femtocell. The UE does not switch its audio path (e.g. voice communications) from UTRAN to Femtocell until handover completion. The UE then performs a handover into the new cell via uplink synchronization (using the provided GHC) to the target FAP on the Uu interface using a Uu-UL Synchronization message 1607. The FAP sends a HANDOVER ACCESS message 1608 to the FGW. The contents of the message allow the FGW to correlate the handover to the Relocation Request Acknowledge message 1604 sent earlier by the FGW to the CN and identify the successful completion of the handover. At this point, the FGW will relay the relevant security keys to the target FAP. If the target FAP receives messages (including signaling messages) from the UE prior to receiving the security keys, it must buffer those messages.

At 1609, the serving FGW sets up a bearer path with the FAP and the UE. Upon completion of synchronization with the target FAP, the UE signals completion of handover using a Physical Channel Reconfiguration Complete message 1610 over the Uu interface.

At 1611, the FAP will initiate an intra-FAP handover, and switch the physical resources to another DCH, thus releasing the GHC to be utilized for a later hand-in (if there are any). The FAP transmits a HANDOVER COMPLETE message 1612, to indicate that as far as the FAP is concerned the handover is finished.

The FGW indicates to the CN that it has detected the UE, using a Relocation Detect message 1613. The CN can optionally now switch the user plane from the source RNC to the target FGW. Bi-directional voice traffic 1614 is now flowing between the UE and CN, via FGW. The target FGW indicates the handover is complete, using the Relocation Complete message 1615. If it has not done so before, the CN now switches the user plane from source RNC to target FGW. The CN tears down the connection to the source RNC, using an Iu Release Command 1616. The source RNC confirms the release of UTRAN resources allocated for this call, using Iu Release Complete message 1617.

D. Minimizing Hand-in Failures Via the Use of Supercells

The following mechanisms may be utilized to minimize the failure of a hand-in to a Femtocell from macro network due to the UE not being present on the correct location of allowed FAPs. A “Supercell” could be defined as an overlay cell to simplify management of handover from UTRAN to Femtocell. The target INC would be configured with this Supercell for the purpose of hand-in.

A Supercell-Id (i.e. target Cell-Id) is configured on a per scrambling code basis. It is expected that scrambling code will be reused for Femtocells and assuming the use of 3 to 5 scrambling codes, will result in configuration of 3-5 Supercell-Ids on the macro RNC (one Supercell-Id for each unique SC). In some embodiments in which both open and closed FAPs are used, the open FAPs have one set of Supercell-ids and the closed FAPs have a separate set of Supercell-ids. In such embodiments, the system will be able to tell from the fact that the UE is sending measurement reports of a FAP with a Supercell-id associated with open FAPs that the UE is near an open FAP and that the messaging associated with open FAPs is appropriate (e.g. the RNC ordering the UE to handover without having to request that the FGW prime a set of FAPs first).

E. Verification of Supercell-Id During Hand-in

During FAP registration with the FGW, the FAP reports the selected {UARFCN, SC} information as part of a Registration message. The FGW will allocate, as part of processing the Registration message, a ‘Supercell-Id” to the FAP based on the reported scrambling code information. This scrambling code information along with the allocated Supercell-Id is stored as part of the FAP registration context in the FGW.

When the FGW receives the relocation message, it retrieves an allowed “FAP list” for the specific UE requesting hand-in. The “Relocation Request” message includes the target cell-id as part of the message. The FGW performs a verification of the target cell-Id against the Supercell-Id stored in the FAP registration context for each of the FAPs in the FAP list. If none of the allowed FAPs in the “FAP list” have a matching macro Supercell-Id, the FGW will reject the hand-in by sending a “Relocation Failure” message back to CN. This will result in the source RNC not attempting a hand-in to Femtocell and will keep the ongoing call on the macro network.

F. Alternate Approach for Minimizing Hand-in Failure

A Supercell-Id (i.e. target Cell-Id) is configured to encode source RNC-Id and source cell-Id of the macro RNC. For example, if the macro RNC represents 100 macro cells, there would be a need to configure 100 Supercell-Ids on the macro RNC as Femtocell neighbors.

During FAP registration with the FGW, the FAP performs a macro network scan and reports a selected macro cell as part of Registration message. The macro cell information carries the RNC-id of the macro network. This is stored as part of the FAP registration context in the FGW. When the FGW receives the relocation message, it retrieves an allowed “FAP list” for the specific UE requesting hand-in. The “Relocation Request” message includes the target cell-id as part of the message. The FGW performs a verification of the 12 bit source RNC-id against the RNC-id stored in the FAP registration context for each of the FAPs in the FAP list. If none of the allowed FAPs in the “FAP list” have a matching macro RNC-id, the FGW will reject the hand-in by sending a “Relocation Failure” message back to CN. This will result in the source RNC not attempting a hand-in to Femtocell and will keep the ongoing call on the macro network.

### V. ALTERNATE EMBODIMENTS

### A. Overview of Alternate Embodiments

As described in the handover procedures, hand-in from UTRAN requires intra- or inter-frequency measurements by the UE. In some embodiments, the serving RNC (SRNC) provides a list of intra- or inter-frequency cells {UARFCN, SC}, based on the configured neighbor list on the serving RNC, in the system information sent to the UE. The UE provides periodic measurement reports for these intra- or inter-frequency cells to the SRNC which would make the hand-in decision based on the reports. The hand-in is triggered by SRNC via the “Relocation Required” command sent to the CN. The “Relocation Required” command contains couple of key attributes for routing the message to appropriate FAP/target RNC. These attributes are: (1) a target RNC, and (2) a target cell-id (contained in the Source RNC to Target RNC transparent container IE).

In some such embodiments, the SRNC is configured with target RNC for the neighbor-list. For example, in some embodiments, each pair of intra- or inter-frequency cells {UARFCN, SC} is mapped to a target RNC on the SRNC. The target RNC attribute is used by the CN to route the Relocation message to the appropriate RNC. Additionally, each pair of intra- or inter-frequency cells {UARFCN, SC} also is mapped to a target cell-id. The target cell-id when received by the target RNC helps to identify the FAP (or Node B in case of macro 3G).

However, this raises some other issues, because in the Femtocell solution the cell-ids are dynamically assigned to each FAP and the range of cell-ids is large (proportional to the number of FAPs deployed in a given PLMN). As a result of this, the SRNC cannot be configured with target cell-ids (as is generally done on a conventional 3G network). Below are the different embodiments to support hand-in with the above constraint.

### B. First Set of Alternate Embodiments

These embodiments use the concept of “Supercells” for mapping a list of intra- or inter-frequency cells {UARFC, SC} to target cell on the SRNC. As mentioned in section IV.D, a “Supercell” could be defined as an overlay cell to simplify management of handover from UTRAN to a Femtocell. The target INC is configured with this Supercell for the purpose of hand-in. When the target INC receives the “Supercell” as identified by the target cell-id attribute, it would need to use the UE identity (IMSI) to do a DB lookup to identify the target FAP. The database access could be local on the INC or external such as via an S1 interface. In some embodiments: (1) the FAP would have a closed list of allowed UEs which can receive service using that FAP, and (2) the UE must be associated with only a single FAP (such as home FAP). In some such embodiments, association of multiple FAPs to a UE would void this scheme, since the INC would not know for which target FAP to reserve the physical radio resources.

Once a target FAP has been identified, the INC sends a “Handover Request” message to the target FAP. The target FAP allocates physical resources (such as appropriate radio resource e.g. Primary SC, DPCH, etc) necessary for the UE to connect to the FAP. The target FAP returns the physical attributes to the INC via “Handover Request Ack”. The INC responds back to the SRNC via the CN and sends data necessary for the SRNC to initiate a physical channel reconfiguration on the UE.

### C. Second Set of Alternate Embodiments

In another set of alternate embodiments, the SRNC indicates, in the System information, the list of intra- or inter-frequency cells which the UE should measure. Additionally, the SRNC also indicates to the UE (via “Cell Reporting Quantities” IE) which attributes of the measured cell are to be included by the UE in the periodic measurement report sent to the SRNC. One of the attributes is the “Cell Identity Reporting Indicator” which, when set to TRUE, requires the UE to include the cell-id of the measured cell. However, in some embodiments the UE ignores this attribute and never sends the cell-id in the measurement report. In some such embodiments, the UE does not read the system information of the neighboring cells for measurement reporting. In such embodiments, the UE obtains the information (to be sent in the measurement report) by synchronizing to the pilot channel and does not need to read any packets of that channel. This saves cycles on the UE in situations where it has large neighbor list and it must perform periodic scans for measurements.

However, in some embodiments, the UE sends the cell-id in the measurement report. Thus, in such embodiments, the SRNC does not need any configuration information for the target cell-id in the neighbor list. Instead, the target cell-id is read from the measurement report. Additionally, the cell-id has the RNC-id encoded in it, which results in eliminating the configuration of target RNC for neighbor list as well. These embodiments allow hand-in from UTRAN to any FAP without restricting the UE to FAP association.

### D. Third Set of Alternate Embodiments

Some embodiments restrict the UE to single FAP because of a need to dynamically assign physical radio resource on the target FAP. However, in some embodiments, dedicated resources (such as fixed scrambling code, dedicated physical channels DPCH) on every FAP are pre-allocated. These resources are “Hand-in channel information”. As a result of this pre-allocation of physical channel, the INC responds to the “Relocation Required” command and includes pre-allocated physical channel information without needing to communicate with the target FAP. The UE eventually synchronizes on the target FAP using this hand-in channel and the target FAP dynamically registers the UE to the INC and confirms the hand-in processing. Once the hand-in from the macrocell has been completed, the target FAP initiates an intra-FAP handover to free up the “hand-in channel” for another UE hand-in.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

### E. Fourth Set of Alternate Embodiments

Some embodiments provide for handover of circuit switched communications. Other embodiments provide for handover of packet switched communications. In some embodiments, both packet switched and circuit switched communications are handed in to the FAPs. In embodiments in which packet switched communications are handed in, the FAPs provide resources to support packet switched communications. In embodiments in which circuit switched communications are handed in, the FAPs provide resources to support circuit switched communications. In embodiments in which circuit and packet switched communications are handed in, the FAPs provide resources to support both packet and circuit switched communications.

### VI. Computer System

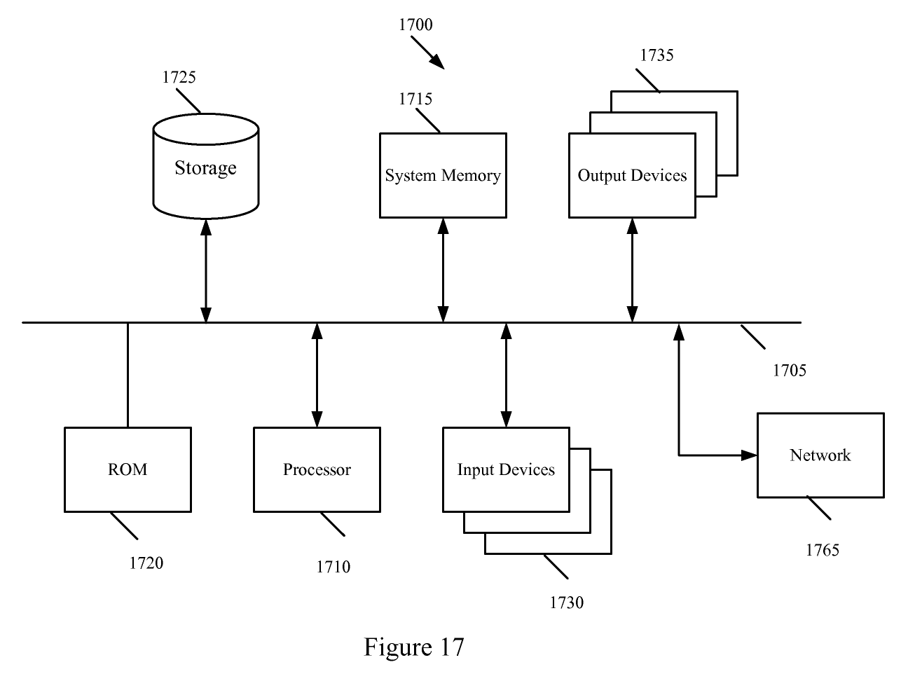

FIG. 17 conceptually illustrates a computer system with which some embodiments of the invention are implemented. The computer system 1700 includes a bus 1705, a processor 1710, a system memory 1715, a read-only memory 1720, a permanent storage device 1725, input devices 1730, and output devices 1735.

The bus 1705 collectively represents all system, peripheral, and chipset buses that support communication among internal devices of the computer system 1700. For instance, the bus 1705 communicatively connects the processor 1710 with the read-only memory 1720, the system memory 1715, and the permanent storage device 1725.

From these various memory units, the processor 1710 retrieves instructions to execute and data to process in order to execute the processes of the invention. In some embodiments the processor comprises a Field Programmable Gate Array (FPGA), an ASIC, or various other electronic components for executing instructions. The read-only-memory (ROM) 1720 stores static data and instructions that are needed by the processor 1710 and other modules of the computer system. The permanent storage device 1725, on the other hand, is a read-and-write memory device. This device is a non-volatile memory unit that stores instruction and data even when the computer system 1700 is off. Some embodiments of the invention use a mass-storage device (such as a magnetic or optical disk and its corresponding disk drive) as the permanent storage device 1725. Some embodiments use one or more removable storage devices (flash memory card or memory stick) as the permanent storage device.

Like the permanent storage device 1725, the system memory 1715 is a read-and-write memory device. However, unlike storage device 1725, the system memory is a volatile read-and-write memory, such as a random access memory. The system memory stores some of the instructions and data that the processor needs at runtime.

Instructions and/or data needed to perform processes of some embodiments are stored in the system memory 1715, the permanent storage device 1725, the read-only memory 1720, or any combination of the three. For example, the various memory units include instructions for processing multimedia items in accordance with some embodiments. From these various memory units, the processor 1710 retrieves instructions to execute and data to process in order to execute the processes of some embodiments.

The bus 1705 also connects to the input and output devices 1730 and 1735. The input devices enable the user to communicate information and select commands to the computer system. The input devices 1730 include alphanumeric keyboards and cursor-controllers. The output devices 1735 display images generated by the computer system. The output devices include printers and display devices, such as cathode ray tubes (CRT) or liquid crystal displays (LCD). Finally, as shown in FIG. 17, bus 1705 also couples computer 1700 to a network 1765 through a network adapter (not shown). In this manner, the computer can be a part of a network of computers (such as a local area network (LAN), a wide area network (WAN), or an Intranet) or a network of networks (such as the Internet).

It should be recognized by one of ordinary skill in the art that any or all of the components of computer system 1700 may be used in conjunction with the invention. For instance, some or all components of the computer system described with regards to FIG. 17 comprise some embodiments of the UE, FAP, FGW, and other devices described above. Moreover, one of ordinary skill in the art will appreciate that any other system configuration may also be used in conjunction with the invention or components of the invention.

Some embodiments of the above mentioned devices, such as the UE 302, FAP 304, or FGW 308, include electronic components, such as microprocessors and memory, that store computer program instructions for executing wireless protocols for managing voice and data services in a machine-readable or computer-readable medium as described above. Examples of machine-readable media or computer-readable media include, but are not limited to magnetic media such as hard disks, memory modules, magnetic tape, optical media such as CD-ROMS and holographic devices, magneto-optical media such as optical disks, and hardware devices that are specially configured to store and execute program code, such as application specific integrated circuits (ASICs), programmable logic devices (PLDs), ROM, and RAM devices. Examples of computer programs or computer code include machine code, such as produced by a compiler, and files containing higher-level code that are executed by a computer, an electronic component, or a microprocessor using an interpreter.

### VII. Abbreviations

| | |
|---|---|
| AAA Server | Authorization, Authentication, and Accounting Server |
| AMS | AP Management System |
| AP | Access Point |
| AS | Access Stratum |
| BSC | Base Station Controller |
| BSS | Base Station Subsystem |
| CMTS | Cable Modem Termination System |
| CN | Core Network |
| DPCH | Dedicated Physical Channels |
| DSLAM | Digital Subscriber Line Access Multiplexer |
| FAP | Femtocell Access Point |
| FGW | Femtocell Gateway |
| GA-CSR | Generic Access - Circuit Switched Resources |
| GAN | Generic Access Network |
| GANC | Generic Access Network Controller |
| GA-PSR | Generic Access - Packet Switched Resources |
| GA-RRC | Generic Access - Radio Resource Control |
| GHC | Global Hand-in Channel |
| GPRS | General Packet Radio Service |
| ICS | Integrated Communication System |
| IMS | IP Multimedia Subsystem |
| IMSI | International Mobile Subscriber Identity |
| INC | IP Network Controller |
| ISDN | Integrated Services Digital Network |
| Iu | Generic term for the standard UMTS interfaces (such |
| | as the Iu-CS, Iu-PS) |
| MAC | Media Access Control |
| MSC | Mobile Switching Center |
| multi-RAB | Multi Radio Access Bearer |
| NAT | Network Address Translation |
| POTS | Plain Old Telephone Service |
| RAN | Radio Access Network |
| RANAP | Radio Access Network Application Part |
| RF | Radio Frequency |
| RNC | Radio Network Controller |
| RRC | Radio Resource Control |
| SAC | Service Access Control |
| SC | Scrambling Code |
| SeGW | Security Gateway |
| SGSN | Serving GPRS Support Node |
| SHC | Shared Hand-in Channel |
| SIM | Subscriber Identity Module |
| | Subscriber Identity Mobile |
| SIP | Session Initiation Protocol |
| SRNC | Serving RNC |
| SSID | Service Set Identifier |
| TCP | Transmission Control Protocol |
| UARFCN | UMTS Absolute Radio Frequency Channel Number |
| UE | User Equipment |
| UL | Uplink |
| UMTS | Universal Mobile Telecommunication System |
| UTRAN | Universal Terrestrial Radio Access Network |
| Uu | Standard UMTS air interface |

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated.

Moreover, while the invention has been described with reference to numerous specific details, one of ordinary skill in the art will recognize that the invention can be embodied in other specific forms without departing from the spirit of the invention. For example, as mentioned above, the FGW in various embodiments comprise generic access network controllers (GANCs), Radio Access Network (RAN) Gateways, Access Gateways, Access Concentrators, or others. The protocols for the messaging in various embodiments use GAN messages (e.g. GA-CSR, GA-PSR, GA-RRC messages), RANAP messages, IMS messages, or other protocols' messages. It will be clear to one of ordinary skill in the art that the message names provided are examples, and that other embodiments may use other message names.

In some embodiments, the functions described with relation to some components can be performed as internal functions of various other components. For example, in some embodiments the AAA, and/or INC functions can be performed by the FGW (and/or AMS) instead. As mentioned above, measurements can be inter- or intra-frequency. One ordinary skill in the art will recognize that some embodiments work with a UMTS licensed wireless system, and some embodiments of the invention use other licensed wireless cellular systems (e.g. Global System for Mobile Communications (GSM), or any other licensed wireless cellular system). One ordinary skill in the art will recognize that some embodiments work with UTRAN licensed wireless connection systems, and some embodiments of the invention use other licensed wireless connection systems (e.g. base station subsystem (BSS), or any other licensed wireless connection systems). One ordinary skill in the art will recognize that some embodiments work with Node B towers, and some embodiments of the invention use other towers (e.g. base transceiver station (BTS), or any other licensed towers). One ordinary skill in the art will recognize that some embodiments work with RNCs, and some embodiments of the invention use other licensed system controllers (e.g. base station controllers (BSCs), or any other licensed system controllers).

In some examples and diagrams, two components may be described or shown as connected to each other. The connection may be a direct wire connection or the two components may be communicatively coupled to each other through other components or through wireless or broadband links. Thus, one of ordinary skill in the art would understand that the invention is not to be limited by the foregoing illustrative details, but rather is to be defined by the appended claims.

What is claimed is:

1. A method of identifying a list of Femtocell access points (FAPs) for a user equipment (UE) communication session in a communication system comprising a first wireless communication system and a second wireless communication system comprising a plurality of FAPs and a Femtocell gateway (FGW) communicatively coupling said FAPs to the first wireless communication system, the method comprising:
a) receiving information about a UE that has detected a particular FAP with an identification attribute;
b) from a first set of FAPs that comprises a plurality of FAP that are not designated for the UE but have a same identification attribute as the particular FAP, using said UE information to retrieve a second set of FAPs designated for said UE that have the same identification attribute as the particular FAP.

2. The method of claim 1, wherein the second set has fewer FAPs than the first FAP.

3. The method of claim 1, wherein the second set of FAPs is an empty set.

4. The method of claim 1, wherein said UE information comprises an international mobile subscriber identity (IMSI) of the UE.

5. The method of claim 1, wherein said FAP identification parameter comprises a scrambling code (SC).

6. The method of claim 1, wherein said FAP identification parameter comprises a universal mobile telecommunication system absolute radio frequency channel number (UARFCN).

7. A method of handing over a communication session of an item of user equipment (UE) in a communication system comprising a first wireless communication system and a second wireless communication system comprising a plurality of Femtocell access points (FAPs) and a Femtocell gateway (FGW) communicatively coupling said FAPs to the first wireless communication system, the method comprising:
a) receiving a request to hand-in a communication session for a UE to a particular FAP, said request comprising an identification of the UE and an identifying parameter of the particular FAP;
b) using said UE identification to identify a set of FAPs that have a same identifying parameter as the particular FAP, wherein the UE is authorized to use the services FAPs in said identified set; and
c) when said identified set comprises at least one FAP, sending a handover request to the FAPs in the identified set, wherein said handover request is for requesting that the FAP in the identified list prepare to receive a handover of said communication session from said first wireless communication system to said FAP on said list of authorized FAPs, wherein said handover request is sent without knowing whether said particular FAP is on said identified set of FAPs which the UE is authorized to use.

8. The method of claim 7, wherein said handing over fails when said first FAP is not on said list of FAPs.

9. The method of claim 7, wherein said identified set comprises only one FAP.

10. The method of claim 7, wherein said identified set comprises a plurality of FAPs.

11. The method of claim 7, wherein said identified set is an empty set.

12. The method of claim 7, wherein said communication session comprises a circuit switched communication session.

13. The method of claim 7, wherein said communication session comprises a packet switched communication session.

14. The method of claim 7, wherein said communication session comprises a packet switched communication session and a circuit switched communication session.

15. The method of claim 7 further comprising receiving a relocation request from a core network of said first wireless communication system.

16. The method of claim 7, wherein said handing over succeeds when said particular FAP is on said identified set.

17. The method of claim 7, wherein said measurement report comprises an identification characteristic of said particular FAP and wherein said identification characteristic is the same as an identification characteristic of a FAP on said identified set.

18. The method of claim 7, wherein said particular FAP is not on said identified set.

19. The method of claim 7, wherein said UE information comprises an international mobile subscriber identity (IMSI) of the UE.

20. The method of claim 7, wherein said FAP identification parameter comprises a scrambling code (SC).

21. A communication system, said system comprising:
a) a first wireless communication system; and
b) a second wireless communication system,
wherein said second wireless communication system comprises:
i) a plurality of Femtocell access points (FAPs);
ii) at least one Femtocell gateway (FGW) communicatively coupling said FAPs to the first wireless communication system; and
iii) a database comprising a first set of identifying parameters by which the FAPs are identified to the first communication system, wherein a plurality of FAPs share a same set of said identifying parameters and cannot be uniquely identified by the first communication system, wherein the database further comprises information for uniquely identifying a set of FAPs that a user equipment is authorized to use.
